(19) United States
(12) Patent Application Publication
(10) Pub. No.: US 2026/0245436 A1
(43) Pub. Date: Aug. 20, 2026

(54) SYSTEM AND METHOD FOR ENHANCING SPECTATOR EXPERIENCE WITH AN AUCTION EVENT

(71) Applicants: Gordon C. Root, West Linn, OR (US); Jeffrey J. Russell, Fountain Hills, AZ (US)

(72) Inventors: Gordon C. Root, West Linn, OR (US); Jeffrey J. Russell, Fountain Hills, AZ (US)

(21) Appl. No.: 19/578,349

(22) Filed: Mar. 25, 2026

Related U.S. Application Data
(63) Continuation-in-part of application No. 19/089,697, filed on Mar. 25, 2025.
Application No. 19/089,697 is a continuation-in-part of application No. 18/898,558, filed on Sep. 26, 2024.
(60) Provisional application No. 63/585,572, filed on Sep. 26, 2023.

(51) Int. Cl. G07F 17/32; G06Q 30/08

(52) U.S. Cl. CPC G07F 17/3288; G06Q 30/08

(57) ABSTRACT

Systems and methods for wagering on an auction event is provided, the auction event comprising at least one offer to bidders of an item for sale and at least one unknown outcome for the at least one offer. At least one unknown outcome is identified to a target group prior to the start of bidding on the item for sale. Funds are received for a plurality of wagers for the at least one unknown outcome and a fund pool is generated based on the funds received for the at least one unknown outcome. Portions of the fund pool are then allocated based on, for example, the wager amount for the at least one unknown outcome, the odds associated with the wager for the at least one unknown outcome, and the wager type for the at least one unknown outcome.

### CROSS REFERENCE TO RELATED APPLICATIONS

This application is a continuation-in-part of U.S. patent application Ser. No. 19/089,697, filed Mar. 25, 2025, which is a continuation-in-part of U.S. patent application Ser. No. 18/898,558, filed Sep. 26, 2024, which claims the priority benefit of U.S. Provisional Patent Application Ser. No. 63/585,572, filed Sep. 26, 2023. The disclosure of each of these priority applications is incorporated herein by reference in its entirety.

### FIELD

The techniques of the disclosure relate broadly to spectator experiences at events, and specific aspects relate to spectator experiences at motorsports events, auction events, and animal events. The techniques of the disclosure include methods and systems that facilitate spectators'interaction with events, enhancing spectators'experience during the event.

### BACKGROUND

Spectator events continue to attract millions of spectators, many of whom are fans, if the events are sports competitions, including motorsports races, or games and matching involving sports, such as track, swimming, golf, football, basketball, baseball and soccer. Spectators engage with those events typically in a passive way by watching them, either live, or by broadcast, cable or streaming. Spectators also engage with events by betting on the outcomes, using conventional platforms.

In addition to sporting events, there are a wide range of other events that involve spectators, and those events include auctions, rodeos, animal events such as equine events and dog shows.

One way that spectators bet on the outcomes of events is via pari-mutuel wagering. Pari-mutuel wagering has largely been associated with horse racing events. The horse racing industry at one time held the status as the most watched sport in the world. However, on-site attendance has been in decline with the advent of off-track betting, followed by the proliferation of other wagering outlets. For example, there has been rising competition from other forms of gambling such as Native American (tribal) casinos, state lotteries, on-line sports betting, greyhound racing, video gaming, and the like. With this increased competition, the on track attendance has suffered. With the on-site attendance for horse racing dropping, the tracks have found it increasingly difficult to financially survive. Additionally, horse racing tracks occupy large tracts of real estate for the backside barns, training tracks, the track itself, grandstands and parking. In many instances the real estate occupied by horse racing tracks has become well-located valuable real estate. As a result, the horse racing tracks close, and the real estate associated with the tracks is sold. The bettors are then displaced and left looking for a viable “like-type” of a gaming experience.

### SUMMARY

The systems, methods, and devices of this disclosure each have several innovative aspects, no single one of which is solely responsible for the desirable attributes disclosed herein. The summary is provided as a preface to assist those skilled in the art to more rapidly assimilate the detailed design discussion which ensues and is not intended in any way to limit the scope of the claims.

In some aspects a method for pari-mutuel wagering includes receiving, by one or more processors prior to and during a race, race data for the race, the race having a plurality of stages, the race data including one or more results of the plurality of stages. The method further includes receiving, by the one or more processors, funds for a plurality of wagers for the race, each wager of the plurality of wagers associated with the one or more of the plurality of stages. The method further includes generating, by the one or more processors, the wagering odds based upon a fund pool determined by the funds wagered on each race participant The method further includes allocating, by the one or more processors, portions of the fund pool based, at least in part, on the one or more results of the plurality of stages and the plurality of wagers.

In some aspects an apparatus for pari-mutuel wagering includes one or more processors. The apparatus further includes a wagering service executable by the one or more processors. The wagering service can be configured to: receive, prior to and during a race, race data for the race, the race having a plurality of stages, the race data including one or more results of the plurality of stages; receive funds for a plurality of wagers for the race, each wager of the plurality of wagers associated with the one or more of the plurality of stages; generate an odds based fund pool based on the funds wagered; and allocate portions of the fund pool based, at least in part, on the one or more results of the plurality of stages and the plurality of wagers.

In some aspects a computer-readable medium includes instructions for causing one or more processors to receive, prior to and during a race, race data for the race, the race having a plurality of stages, the race data including one or more results of the plurality of stages. The instructions further include instructions to cause the one or more processors to receive funds for a plurality of wagers for the race, each wager of the plurality of wagers associated with the one or more of the plurality of stages. The instructions further include instructions to cause the one or more processors to generate a fund pool based on the funds wagered. The instructions further include instructions to allocate portions of the fund pool based, at least in part, on the one or more results of the plurality of stages and the plurality of wagers.

### BRIEF DESCRIPTION OF THE DRAWINGS

To describe the technical solutions in the embodiments of the present disclosure or in the prior art more clearly, the following briefly describes the accompanying drawings required for describing the embodiments or the prior art. Apparently, the accompanying drawings in the following description merely show some embodiments of the present disclosure, and a person of ordinary skill in the art can derive other implementations from these accompanying drawings without creative efforts. All of the embodiments or the implementations shall fall within the protection scope of the present disclosure. Having thus described the disclosure in general terms, reference will now be made to the accompanying figures.

FIG. 1 is a flowchart illustrating a system 100 for enhancing spectator experience during an event, in accordance with an example implementation of the techniques of the disclosure.

FIG. 2 is a block diagram 200 illustrating communication between an event and a group of spectators through the system 100, in accordance with an exemplary example implementation of the techniques of the disclosure.

FIG. 3 is a block diagram 300 illustrating a wager offering module 502 configured to offer wagers to the plurality of spectators 206 on interim outcomes, in accordance with an example implementation of the techniques of the disclosure.

FIG. 4 is a block diagram illustrating a method 400 for enhancing the spectator experience during an event, in accordance with an example implementation of the techniques of the disclosure.

FIG. 5 is a flow chart illustrating a system 500 for use in relation to a motorsport race produced by an event producer, in accordance with an example implementation of the techniques of the disclosure.

FIG. 6 is a block diagram 600 illustrating communication between motorsport race 602 and a plurality of spectators 606 through the system 500, in accordance with an exemplary example implementation of the techniques of the disclosure.

FIG. 7 illustrates a diagrammatic representation 700 illustrating a data processing module 702 configured to amalgamate and reformat the MRRD, in accordance with an example implementation of the techniques of the disclosure.

FIG. 8 is a block diagram illustrating a method 800 for enhancing the spectator experience during a motorsports race, in accordance with an example implementation of the techniques of the disclosure.

FIG. 9 is a flow chart 900 illustrating a system for enhancing spectator experience during an auction, in accordance with an example implementation of the techniques of the disclosure.

FIG. 10 is a diagrammatic representation 1000 of the engagement module 908 associated with the system 900, in accordance with an exemplary example implementation of the techniques of the disclosure.

FIG. 11 is a diagrammatic representation 1100 of an allocation module 1102 associated with the system 900, in accordance with an exemplary example implementation of the techniques of the disclosure.

FIG. 12 is a diagrammatic representation 1200 illustrating the targeting module 904 associated with the system 900, in accordance with an exemplary example implementation of the techniques of the disclosure.

FIG. 13 is a flow chart 1300 illustrating a method for enhancing the spectator experience during an auction, in accordance with an example implementation of the techniques of the disclosure.

FIG. 14 is a block diagram illustrating a system 1400 for enhancing spectator experience during an animal event produced by an event producer, in accordance with an example implementation of the techniques of the disclosure.

FIG. 15 is a diagrammatic representation of a wager offering module 1502 configured to offer wagers to a target group of spectators 1506 on interim outcomes between the beginning time and the completion time.

FIG. 16 is a diagrammatic representation 1600 of the targeting module 1404 associated with the system 1400, in accordance with an example implementation of the techniques of the disclosure.

FIG. 17 is a block diagram illustrating a method 1700 for enhancing the spectator experience during an animal event, in accordance with an example implementation of the techniques of the disclosure.

FIG. 18 is a block diagram illustrating a system for conducting parimutuel wagering on multi-stage events.

FIG. 19A is a conceptual diagram illustrating an example first wagering period for a multi-stage event.

FIG. 19B is a conceptual diagram illustrating an example second wagering period for the multi-stage event.

FIG. 19C is a conceptual diagram illustrating an example third wagering period for the multi-stage event.

FIG. 19D is a conceptual diagram illustrating an example fourth wagering period for the multi-stage event.

FIG. 20 is a flow chart diagram illustrating example operations for conducting parimutuel wagering on multi-stage events.

FIG. 21 is a block diagram of an example computer system upon which embodiments of the inventive subject matter can execute.

It should be noted that the accompanying figures are intended to present illustrations of a few examples of the present disclosure. The figures are not intended to limit the scope of the present disclosure. It should also be noted that the accompanying figures are not necessarily drawn to scale.

### DETAILED DESCRIPTION OF THE INVENTION

In the following detailed description of the invention, numerous specific details are set forth in order to provide a thorough understanding of the invention. However, it will be obvious to a person skilled in the art that the invention may be practiced with or without these specific details. In other instances, well-known methods, procedures and components have not been described in detail so as not to unnecessarily obscure aspects of the invention.

The accompanying drawing is used to help easily understand various technical features and it should be understood that the alternatives presented herein are not limited by the accompanying drawing. As such, the present disclosure should be construed to extend to any alterations, equivalents and substitutes in addition to those which are particularly set out in the accompanying drawing. Although the terms first, second, etc. may be used herein to describe various elements or values, these elements or values should not be limited by these terms. These terms are generally only used to distinguish one element or values from another.

It will be apparent to those skilled in the art that other alternatives of the invention will be apparent to those skilled in the art from consideration of the specification and practice of the invention. While the foregoing written description of the invention enables one of ordinary skill to make and use what is considered presently to be the best mode thereof, those of ordinary skill will understand and appreciate the existence of variations, combinations, and equivalents of the specific aspect, method, and examples herein. The invention should therefore not be limited by the above described alternative, method, and examples, but by all aspects and methods within the scope of the invention. It is intended that the specification and examples be considered as exemplary, with the true scope of the invention being indicated by the claims.

Conditional language used herein, such as, among others, “can,” “may,” “might,” “may,” “e.g.,” unless specifically stated otherwise, or otherwise understood within the context as used, is generally intended to convey that certain alternatives include, while other alternatives do not include, certain features, elements and/or steps. Thus, such conditional language is not generally intended to imply that features, elements and/or steps are in any way required for one or more alternatives or that one or more alternatives necessarily include logic for deciding, with or without other input or prompting, whether these features, elements and/or steps are included or are to be performed in any particular alternative. The terms “comprising,” “including,” “having” are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The techniques of the disclosure provide systems and methods to enhance spectators'experiences for events. One implementation of the techniques of the disclosure is a system and method for implementing pari-mutuel wagering in sports events worldwide. This system leverages the existing infrastructure already in existence for pari-mutuel betting on horse racing, including dedicated software, betting outlets, web pages, and apps. By adapting and extending this infrastructure to encompass a wide variety of sports, the invention opens up the opportunity for spectators to interact with a variety of sports events through wagering.

The techniques of the disclosure amalgamate event-related data and then integrate that data into a system and method that allows spectators to make informed wagers. Event-related data may include team statistics, participant information, historical performance, real-time match or game statistics, and other pertinent data that enrich the spectator's understanding of the event and increase their engagement. This data-driven approach provides a valuable connection between the sporting event and the spectator's betting experience.

The integration of pari-mutuel wagering into sports events offers a novel and exciting way for spectators to enjoy the games they love. It transforms them from passive observers into active participants, contributing to and sharing in the wagering pool. This not only enhances the excitement of sports events but also fosters a sense of community and engagement among fans.

The techniques of the disclosure bridge the world of sports events with the established framework of pari-mutuel betting, providing fans with an innovative and interactive way to connect with their favorite sports. By capitalizing on existing infrastructure and offering a platform for wagering on a variety of sports and other events, the system and method enhances the spectator experience by offering a more immersive and engaging one to event spectators worldwide.

In some aspects, the techniques of the disclosure offer ways to enhance spectators'experiences.

In some aspects, the techniques of the disclosure establish a novel approach for sports betting, introducing the concept of pari-mutuel wagering to motorsports and other sports events. Such aspects enhance the enjoyment and engagement of sports enthusiasts by enabling them to actively participate in wagering on their favorite teams, athletes, or sporting events.

In some aspects the techniques of the disclosure extend the functionality of pari-mutuel wagering on various sports events, creating a seamless transition for both betting operators and spectators.

In some aspects the techniques of the disclosure provide spectators with event-related data that informs their wagering decisions. This data may include real-time statistics, historical performance, player or team profiles, and other relevant information, enriching the betting experience. Such aspects enable informed wagering and enhance the connection between the spectator and the sports event.

In some aspects the techniques of the disclosure transform spectators from passive observers into active participants, offering them an engaging and interactive role in the sports event. Such aspects create a more immersive and dynamic spectator experience by allowing spectators to wager on various aspects of the event, thus increasing their emotional investment and enjoyment.

In some aspects the techniques of the disclosure provide a universally accessible platform for sports betting and engagement.

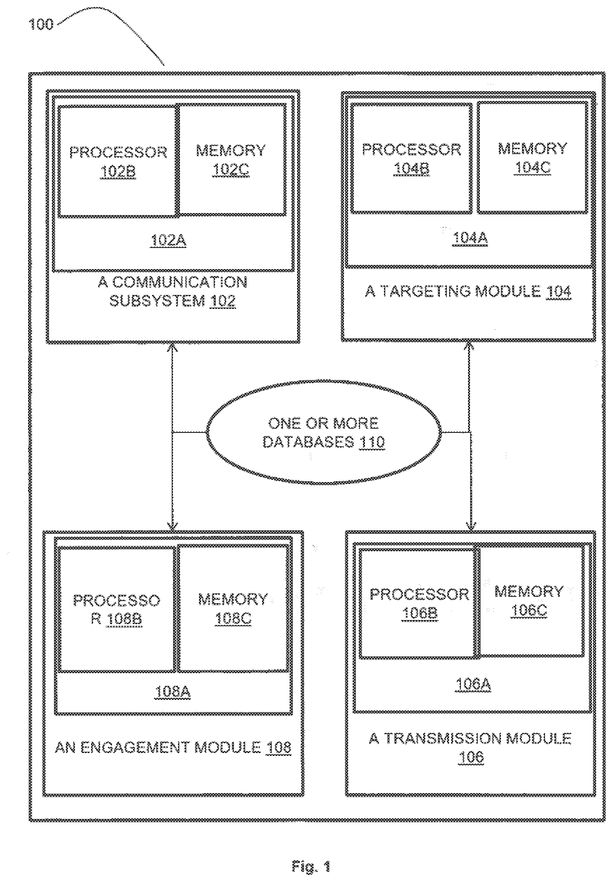

FIG. 1 is a flowchart illustrating a system 100 for enhancing spectator experience during an event, in accordance with an example implementation of the techniques of the disclosure. The system 100 may be produced by an event producer for use in relation to the event. In some implementations, the event may be any of but not limited to a motorsports race, an athletic event, an animal event, a car race, or an auction. In addition, the event may occur between a beginning time up to the end time and may produce one or more categories of interim outcomes between the beginning time up to the end time. The interim outcomes may be unknown prior to the beginning time.

In some implementations, the system 100 may be configured to identify the one or more categories of interim outcomes to a target group of spectators. In addition, the system 100 may be configured to report to the target group of spectators in a period between the beginning time and the end time the interim outcomes as they become known during the event. Further, the system 100 may measure a level of spectator engagement with the event.

In a specific example implementation of the techniques of the disclosure, the system 100 may include a communication subsystem 102, a targeting module 104, a transmission module 106 and an engagement module 108. Other implementations of the techniques of the disclosure may or may not include other modules to implement the techniques.

In some implementations, the communication subsystem 102 may be configured to acquire event-related data (ERD) for the event. The ERD may include one or more categories of interim outcomes before the beginning time of the event and the interim outcomes as they become known during the event.

In some implementations, the communication subsystem 102 may include a control subsystem 102a. The control subsystem 102a may include a processor 102b, at least one database 110 and a computer readable memory 102c including a processor-readable instruction that is executed by the processor 102b and cause the processor 102b to acquire the event-related data (ERD) for the event. The computer readable memory 102c in the control subsystem 102a may be used to store the ERD.

The processor 102b associated with the control subsystem 102a may be any well-known processor, but not limited to processors from Intel Corporation. Alternatively, the processor may be a dedicated controller such as an ASIC or ARM, MIPS, SPARC, or INTEL® IA-32 microcontroller.

Similarly, in yet another example implementation of the techniques of the disclosure, the processor 102b may comprise a collection of processors which may or may not operate in parallel. The processor 102b may be any processor-driven device, such as may include one or more microprocessors and memories or other computer-readable media operable for storing and executing computer-executable instructions. Examples of processor-driven devices may include, but are not limited to, a server computer, a mainframe computer, one or more networked computers, a desktop computer, a personal computer, an application-specific circuit, a microcontroller, a minicomputer, or any other processor-based device.

Also, the processor 102b may execute any set of instructions directly as computer executable codes or indirectly (such as scripts). In that regard, the terms “instructions,” and “steps” may be used interchangeably herein. The instructions may be stored in object code form for direct processing by the processor 102b, or in any other computer language including scripts or collections of independent source code modules that are interpreted on demand or compiled in advance.

In accordance with an example implementation of the techniques of the disclosure, the computer readable memory 102c is configured with the processor 102b for storing the ERD. For example, the computer readable memory 102c may store software used by a user interface or the processor, such as an operating system (not shown), application programs (not shown), and an associated internal database (not shown).

In addition, the computer readable memory 102c associated with the control subsystem 102a stores instructions to be executed by the control subsystem 102a. The computer readable memory 120c can be any type of suitable memory, including various types of dynamic random-access memory (DRAM) such as SDRAM, various types of static RAM (SRAM), and various types of non-volatile memory (PROM, EPROM, and flash). It should be understood that the computer readable memory 102c may be a single type of memory component or it may be composed of many different types of memory components. As noted above, the computer readable memory 102c stores instructions for executing one or more methods for enhancing spectator experience during an event. For example, the computer readable memory may store software used by the user device, such as an operating system (not shown), application programs (not shown), and an associated internal database (not shown). In an alternative embodiment, the computer readable memory 102c may be an external memory to the control subsystem 102a to store various data and computer executable instructions.

In some embodiments, the computer readable memory 102c may communicate with the processor(s) via a system bus. It may include one or more non transitory storage units and one or more optional removable non transitory storage units that may include interfaces or device controllers (not shown) communicably coupled between non transitory storage unit and the system bus, as is known by those skilled in the relevant art. The non transitory storage units, and their associated storage devices provide non-volatile storage of computer-readable instructions, data structures, program modules and other data for the processor. Those skilled in the relevant art will appreciate that other types of storage devices may be employed to store digital data accessible by a computer, such as magnetic cassettes, flash memory cards, RAMs, ROMs, smart cards, etc.

As an example, and not by way of limitation, the computer readable memory 102c may comprise one or more non-transitory storage mediums. Such non-transitory storage medium may include, but is not limited to, any current or future developed persistent storage device. Such persistent storage devices may include, without limitation, magnetic storage devices such as hard disc drives, electromagnetic storage devices such as memristors, molecular storage devices, quantum storage devices, electrostatic storage devices such as solid-state drives.

In some implementations, the communication subsystem 102 may include one or more sensors (not shown in figures) for real-time data acquisition of the event. In an example, the one or more sensors may be placed to monitor conditions such as temperature, humidity and wind speed, climate condition, air condition, air quality, air index, moisture level of the place where the event is held. In accordance with an example implementation of the techniques of the disclosure, the data from the one or more sensors is transmitted to the target group of spectators.

In some implementations, the communication subsystem 102 may be configured to acquire transmission signals of live events, chosen from the group consisting of broadcast and streaming signals. In an exemplary embodiment, the communication subsystem 102 may be wired or wireless. The wired communication may include any of but not limited to landline phones which uses copper wires transmit voice signals and fibre-optic communication which transmits data using light signals through optical fibres. The wireless communication may include but not limited to Wi-Fi which may allow devices to connect through the internet and communicate wirelessly and Bluetooth which may be used for short-range connections between devices like headphones and smart phones. In addition, the communication subsystem 102 may be any of but not limited to a plurality of smart phones which use cellular networks to transmit voice, text messages, and data and a plurality of cell towers which use relay signals from the phones to the network.

In another example, the communication subsystem 102 may be a telemetry system which allows for real-time analysis and decision-making during the event in which events equipment are equipped with the telemetry system that continuously transmit ERD (event related data), including performance of a vehicle used in case of a racing event, speed, tire condition, fuel levels of a vehicle, and driver biometrics of a vehicle, back to the spectator which allows for real-time analysis and decision-making during the event.

In yet another example, the communication subsystem 102 may include cameras mounted on race cars to capture video footage in case of a racing event, which is streamed to the event control center and broadcasted to the fans. In yet another example, the communication system 102 may integrate with timing and scoring equipment to provide precise information about lap times, sector times and event positions to teams, race control and spectators in case of a racing event. In yet another example, the communication system 102 may include any of trackside sensors, GPS tracking, race data analysis tools, driver biometrics, team communication networks and data distribution to spectators in the case of racing event. The above-mentioned examples may illustrate that a communication system may be configured to acquire, process, and distribute event-related data (ERD) to various spectators, enhancing the event experience and ensuring the safety and efficiency of the event.

In some implementations, the targeting module 104 may be configured to select the target group of spectators based on a predetermined criterion. In some implementations, the predetermined criteria for selecting the target group of spectators may include at least one of geographical location, user preferences, and user demographics. In another example implementation of the techniques of the disclosure, the predetermined criterion may or may not include other parameters performing similar function.

In some implementations, the targeting module 104 may include a control subsystem 104a. The control subsystem may include a processor 104b, the least one database 110 and a computer readable memory 104c including a processor-readable instruction that may be executed by the processor 104b and may cause the processor 104b to select the target group of spectators based on the predetermined criterion. The computer readable memory 104c in the control subsystem 104a may be used to store the target group of spectators.

In some implementations, the processor 104b, the computer readable memory 104c and the one or more database 110 of the targeting module 104 may be any of the above-mentioned processor, memory and database used for the communication subsystem 102.

In an example, the targeting module 104 may select the target group of spectators by using a ticket type targeting in which different ticket categories can be used as a criterion to tailor messages, offers, and experiences to specific ticket holders. In another example, the targeting module 104 may select the target group of spectators using location-based targeting in which spectators situated in different areas can receive targeted information.

In yet another example, the targeting module 104 may select the target group of spectators by determining their interests, such as favorite teams or drivers in case of a racing event, and deliver updates, statistics, and special content related to those preferences. In yet another example, the targeting module 104 may select the target group of spectators based on engagement level in which spectators who actively engage with the event app or show a high level of interest by checking into different event locations can receive rewards or recognition for their participation.

In some implementations, the targeting module 104 may select the target group of spectators based on user demography in which criteria such as age, gender or language preference can be used to customize content and promotions. For instance, families with children might receive information about on-site activities at the event.

In some implementations, the transmission module 106 is configured to transmit the acquired ERD to the target group of spectators. In some implementations, the transmission module 106 may include a control subsystem 106a. The control subsystem may include a processor 106b, the least one database 110 and a computer readable memory 106c may include a processor-readable instruction that is executed by the processor 106b and may cause the processor 106b to transmit the acquired ERD to the target group of spectators.

In some implementations, the processor 106b, the computer readable memory 106c and the one or more databases 110 of the transmission module 106 may be any of the above-mentioned processors, memory and databases.

In an example, the transmission module 106 may transmit the acquired ERD to the target group of spectators before the beginning time of the event and during the event by delivering real-time commentary, event updates, and announcements to spectators, providing insights into the event, driver statistics, and event-related news.

In another example, the transmission module 106 may transmit the acquired ERD to the target group of spectators by using live audio where spectators can access live radio broadcasts or audio commentary on their smartphones or portable radios, allowing them to choose their preferred audio feed, including team radio communications.

In yet another example, the transmission module 106 may transmit the acquired ERD to the target group of spectators by providing live event coverage and in-car camera feeds on their smartphones or tablets. Different camera angles and driver-specific feeds can be offered for a more personalized experience.

In yet another example, the transmission module 106 may transmit the acquired ERD by using real-time leader boards and statistics, fan engagements apps, social media feeds, and fan zone information.

In some implementations, the engagement module 108 may allow the target group of spectators to interact with the event by using the ERD, causing the spectators to have an enhanced spectator experience. In some implementations, the enhanced spectator experience caused by the engagement module 108 may be chosen from the group consisting of participants in the event, having an emotional experience during the event, enjoying the event more than they would have without the system, betting on the outcome of the event, or a combination of each of those things. In addition, the engagement module 108 may measure the level of spectator engagement in the event.

In some implementations, the engagement module 108 may allow for the target group of spectators to place wagers between the beginning time and the end time on one or more of the interim outcomes. In addition, the engagement module 108 may measure the level of spectator engagement based at least in part from the wagers placed by the target group of spectators.

The engagement module 108 may measure the level of spectator engagement based on at least one factor chosen from the group consisting of participating in the event, having an emotional experience during the event, enjoying the event more than they would have without the system, betting on the outcome of the event, or a combination of each of those things. Further, the engagement module 108 may enable the target group of spectators to place bets on various event outcomes chosen from the group consisting of final times, final scores, driver statistics, player statistics, specific race events, and specific game events.

In some implementations, the system 100 may further include a data processing module configured to analyze the ERD and provide real-time odds for betting on the event outcome based on the analyzed data. In some implementations, the system 100 may establish a two-way communication between the event and the spectator. The two-way communication allows the spectator to have enhanced engagement with the event.

In some implementations, the engagement module 108 includes a control subsystem 108a. The control subsystem 108a may include a processor 108b, the least one database 110 and a computer readable memory 108c including a processor-readable instruction that is executed by the processor 108b and may cause the processor 108b to interact with the event by using the ERD, causing the spectators to have an enhanced spectator experience.

In some implementations, the processor 108b, the computer readable memory 108c and the one or more database 110 of the engagement module 108 may be any of the above-mentioned processor, memory and database used for the communication subsystem 102.

In some implementations, the engagement module 108 may enable the target group of spectators to place bets on various event outcomes chosen from the group consisting of final times or results, final scores, driver statistics, participant statistics, specific race events, and specific game events.

In an example, a dedicated mobile app may allow spectators to place wagers on various race outcomes, such as the winner, podium winner, podium finishers, fastest lap, or the number of safety car periods. In another example, the engagement module 108 may allow interaction of the target group of spectators by providing a live betting platform where spectators can use a real-time betting platform to make dynamic wagers during the event, adjusting their bets as the event unfolds.

In yet another example, the engagement module 108 may allow interaction of the target group of spectators providing driver performance betting such in which wagers can be placed on individual driver performance, such as predicting the number of overtakes, the driver with the most laps led, or who will finish as the top-ranked driver for a particular team. In yet another example, the engagement module 108 may allow participation of the target group of spectators by using championship betting, safety car betting, driver head-to-head betting, live betting challenges, in race betting contests, and social betting pools.

In some implementations, the system 100 may include a wager offering module configured to offer wagers to the target group of spectators on interim outcomes between the beginning time and the end time.

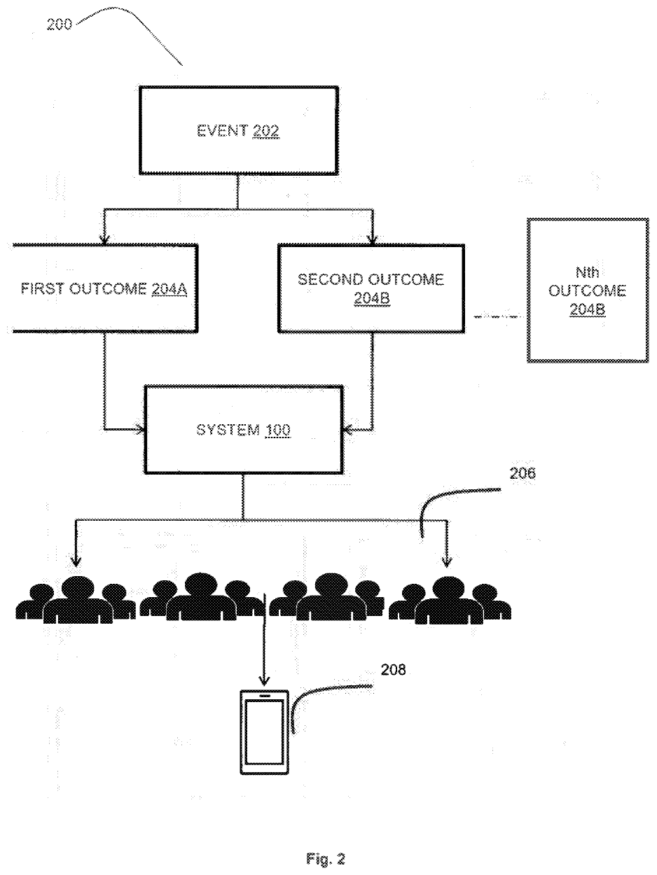

FIG. 2 is a block diagram 200 illustrating the communication between an event 202 and a group of spectators 206 through the system 100, in accordance with an exemplary example implementation of the techniques of the disclosure. The event may include “n” outcomes, where n is a natural number. In an example, the event may include a first outcome 204a and a second outcome 204b.

In some implementations, the system 100 may provide wagers to the plurality of spectators 206 to engage with the event 202. The plurality of spectators participates in the event 202 by applying on the outcomes of the event, where the outcome may be the first outcome 204a, the second outcome 204b up to the nth outcome of the event 202.

In some implementations, the plurality of spectators 206 may receive ongoing statistics related to the outcomes of the event 202 on their mobile phones 208. The mobile phones 208 may allow the plurality of spectators 206 to communicate with the event 202 through the mobile phone 208. The communication between the plurality of spectators 206 and the event 202 may be a two-way communication which enhances the event engagement.

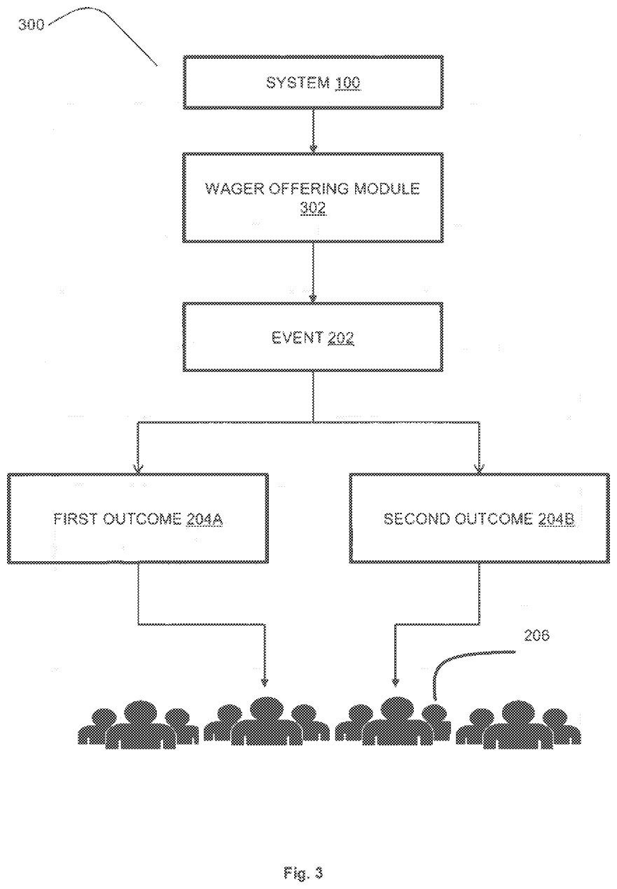

FIG. 3 is a block diagram 300 illustrating a wager offering module 502 configured to offer wagers to the plurality of spectators 206 on interim outcomes between the beginning time and the end time, in accordance with an example implementation of the techniques of the disclosure (References have been made to FIG. 1 and FIG. 2).

In some implementations, the wager offering module 502 may be associated with the system 100. In an example, the event 202 has one or more outcomes which may include any of but may not be limited to the first outcome 204a and the second outcome 204b. In addition, the wager offering module 502 may enhance engagement of the plurality of spectators 206 with the event 202 by offering wagers on the one or more outcomes of the event 202.

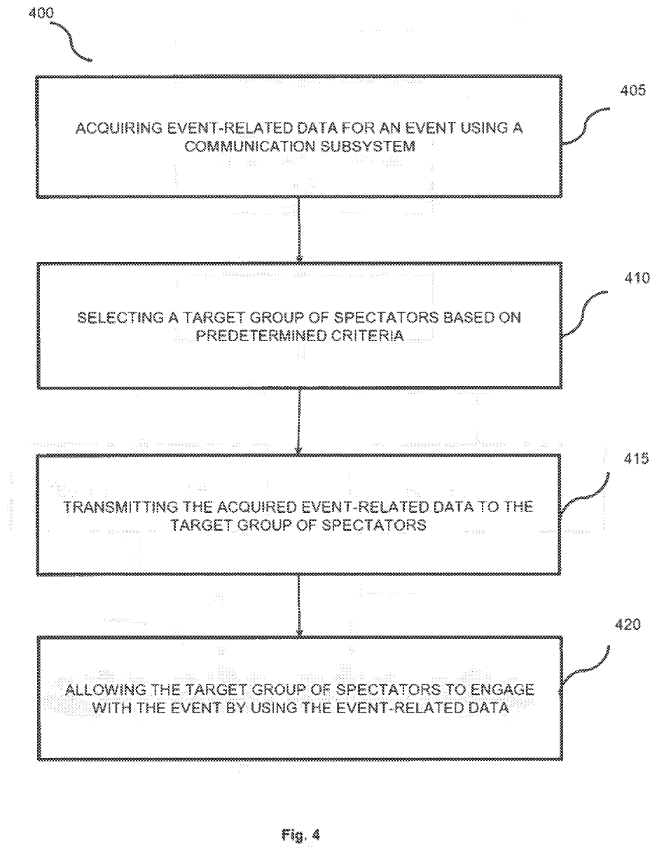

FIG. 4 is a block diagram illustrating a method 400 for enhancing the spectator experience during an event, in accordance with an example implementation of the techniques of the disclosure. In one specific embodiment, the flow chart 400 may include steps to illustrate the method for enhancing the spectator experience during the event. Other embodiments may include other steps to illustrate similar methods.

In some implementations, the method may initiate at step 405 and terminates at step 420. At step 405, the method 400 may include acquiring an event-related data (ERD) for the event using a communication subsystem 102. (References have been made to FIG. 1)

At step 410, a target group of spectators may be selected based on a predetermined criterion. In some implementations, the predetermined criteria for selecting the target group of spectators may include at least one of geographical location, user preferences, and user demographics. In another example implementation of the techniques of the disclosure, the predetermined criteria may or may not include other parameters performing similar function.

At step 415, the acquired ERD may be transmitted to the target group of spectators. At step 220, the target group of spectators may be allowed to engage with the event by using the ERD, causing the spectators to have an enhanced spectator experience. In some implementations, the enhanced spectator experience caused by the allowing step 420 may be chosen from the group consisting of participants in the event. The participants may have an emotional experience during the event, enjoying the event more than they would have without the system 100, betting on the outcome of the event, or a combination of each of those things.

In some implementations, the step 420 of allowing the target group of spectators to engage with the event may include placing wagers on various event outcomes chosen from the group consisting of final times, final scores, driver statistics, player statistics, specific race events, and specific game events. In another example implementation of the techniques of the disclosure, the group of various event outcomes may include any other parameters relating to a specific game.

In some implementations, the method 400 further includes real-time analysis of the ERD to provide updated odds for betting to the target group of spectators. In some implementations, all the ERD may be amalgamated into a standardized data format to enable transmission through a plurality of third parties involved in the event.

In an exemplary example implementation of the techniques of the disclosure, a computer-readable medium may include computer-executable instructions for implementing the method for enhancing spectator experience during an event. In an example, the computer readable medium may be any of but not limited to a memory card which can store software and instructions, CD-ROM that can be read by a computer's optical drive, DVD, USB Flash Drive, Hard Disk Drive to store both data and execute instructions, Solid State Drive, Magnetic Tape, Cloud Storage in which files and instructions are stored like Google Drive or drop box, network storage, remote repositories, ROM, EPROM and EEPROM.

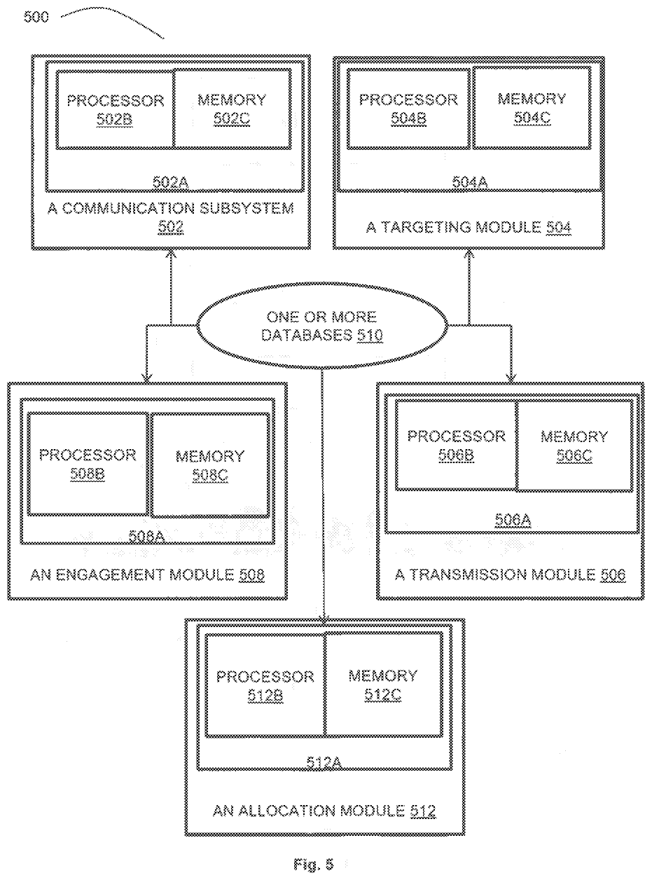

FIG. 5 is a flow chart illustrating a system 500 for use in relation to a motorsport race produced by an event producer, in accordance with an example implementation of the techniques of the disclosure. The system 500 may be configured for collecting wagers from a betting populace and for allocating a portion of the wagers as revenue to the event producer and for enhancing experience of a plurality of spectators during a motorsport race. In a specific embodiment, the system 500 may include a communication subsystem 502, a targeting module 504, a transmission module 506, an engagement module 508, an allocation module 512 and one or more databases 510. Other implementations of the techniques of the disclosure may or may not include other modules to implement the techniques.

In some implementations, the communication subsystem 502 may be configured to acquire motorsport race-related data (MRRD) for the motorsport race. In some implementations, the communication subsystem 502 may include a control subsystem 502a. The control subsystem 502a may include a processor 502b, at least one database 510 and a computer readable memory 502c which may include a processor-readable instruction that is executed by the processor 502b and may cause the processor 502b to acquire the motorsport race-related data (MRRD) for the motorsport race. The computer readable memory 502c in the control subsystem 502a may be used to store the MRRD.

The processor 502b may be associated with the control subsystem 502a may be any well-known processor, but may not be limited to processors from Intel Corporation. Alternatively, the processor 502b may be a dedicated controller such as an ASIC or ARM, MIPS, SPARC, or INTEL® IA-32 microcontroller.

Similarly, in yet another example implementation of the techniques of the disclosure, the processor 502b may comprise a collection of processors which may or may not operate in parallel. The processor 502b may be any processor-driven device, such as may include one or more microprocessors and memories or other computer-readable media operable for storing and executing computer-executable instructions. Examples of processor-driven devices may include, but are not limited to, a server computer, a mainframe computer, one or more networked computers, a desktop computer, a personal computer, an application-specific circuit, a microcontroller, a minicomputer, or any other processor-based device.

Also, the processor 502b may execute any set of instructions directly as computer executable codes or indirectly (such as scripts). In that regard, the terms “instructions,” and “steps” may be used interchangeably herein. The instructions may be stored in object code form for direct processing by the processor 502b, or in any other computer language including scripts or collections of independent source code modules that are interpreted on demand or compiled in advance.

In accordance with an example implementation of the techniques of the disclosure, the computer readable memory 502c may be configured with the processor 502b for storing the ERD. For example, the computer readable memory 502c may store software used by a user interface or the processor 502b, such as an operating system (not shown), application programs (not shown), and an associated internal database (not shown).

In addition, the computer readable memory 502c may be associated with the control subsystem 502a stores instructions to be executed by the control subsystem 502a. The computer readable memory 502c may be any type of suitable memory, including various types of dynamic random-access memory (DRAM) such as SDRAM, various types of static RAM (SRAM), and various types of non-volatile memory (PROM, EPROM, and flash). The computer readable memory 502c may be a single type of memory component or it may be composed of many different types of memory components. As noted above, the computer readable memory 502c stores instructions for executing one or more methods for enhancing spectator experience during the race. For example, the computer readable memory 502c may store software used by the user device, such as an operating system (not shown), application programs (not shown), and an associated internal database (not shown). In an alternative embodiment, the computer readable memory 502c may be an external memory to the control subsystem 502a to store various data and computer executable instructions.

In some embodiments, the computer readable memory 502c may communicate with the processor(s) via a system bus. It may include one or more non transitory storage units and one or more optional removable non transitory storage units that may include interfaces or device controllers (not shown) communicably coupled between non transitory storage unit and the system bus, as is known by those skilled in the relevant art. The non transitory storage units, and their associated storage devices provide non-volatile storage of computer-readable instructions, data structures, program modules and other data for the processor. Those skilled in the relevant art will appreciate that other types of storage devices may be employed to store digital data accessible by a computer, such as magnetic cassettes, flash memory cards, RAMs, ROMs, smart cards, etc.

As an example, and not by way of limitation, the computer readable memory 502c may comprise one or more non-transitory storage mediums. Such non-transitory storage medium may include, but is not limited to, any current or future developed persistent storage device. Such persistent storage devices may include, without limitation, magnetic storage devices such as hard disc drives, electromagnetic storage devices such as memristors, molecular storage devices, quantum storage devices, and electrostatic storage devices such as solid-state drives.

In some implementations, the communication subsystem 502 may include one or more sensors (not shown in figures) for real-time data acquisition of the motorsport race. In an example, the one or more sensors may be placed around the racetrack to monitor environmental conditions such as temperature, humidity and wind speed, track condition such as grip levels and debris, safety status. In accordance with an example implementation of the techniques of the disclosure, the data from the one or more sensors may be transmitted to the plurality of spectators.

In some implementations, the communication subsystem 502 may be configured to acquire transmission signals of live motorsport races, chosen from the group consisting of broadcast and streaming signals. In an example, the communication subsystem 502 may be wired or wireless. The wired communication includes but not limited to landline phones which uses copper wires transmit voice signals and fibre-optic communication which transmits data using light signals through optical fibres. The wireless communication includes but not limited to Wi-Fi which allows devices to connect through the internet and communicate wirelessly and Bluetooth which is used for short-range connections between devices like headphones and smart phones. In addition, the communication subsystem 502 may be any of but not limited to a plurality of smart phones which use cellular networks to transmit voice, text messages, and data and a plurality of cell towers which use relay signals from the phones to the network.

In another example, the communication subsystem 502 may be a telemetry system which allows for real-time analysis and decision-making during the race. in which race cars are equipped with the telemetry system that continuously transmit MRRD, including engine performance, speed, tire condition, fuel levels, and driver biometrics, back to the team's pit area which allows for real-time analysis and decision-making during the race.

In yet another example, the communication subsystem 502 may include cameras mounted on race cars to capture video footage, which is streamed to the race control center and broadcasted to the fans. In yet another example, the communication system 502 may integrate with timing and scoring equipment to provide precise information about lap times, sector times and race positions to teams, race control and spectators. In yet another example, the communication system 502 may include any of trackside sensors, GPS tracking, race data analysis tools, driver biometrics, team communication networks and data distribution to spectators. The above-mentioned examples illustrate that a communication system can be configured to acquire, process, and distribute motorsport race-related data (MRRD) to various spectators, enhancing the racing experience and ensuring the safety and efficiency of motorsport events.

In some implementations, the targeting module 504 may be configured to select a target group of spectators from the plurality of spectators based on a predetermined criterion. In some implementations, the targeting module 504 may include a control subsystem 504a. The control subsystem includes a processor 504b, the least one database 510 and a computer readable memory 504c which includes a processor-readable instruction that is executed by the processor 504b and causes the processor 504c to select the target group of spectators based on the predetermined criterion. The computer readable memory 504c in the control subsystem is used to store the target group of spectators.

In some implementations, the processor 504b, the computer readable memory 504c and the one or more database 510 of the targeting module 504 may be any of the above-mentioned processors, memory and databases used for explaining the communication subsystem 502.

In some implementations, the predetermined criteria for selecting the target group of spectators includes at least one of geographical location, user preferences, and user demographics. In another example implementation of the techniques of the disclosure, the predetermined criterion may or may not include other parameters performing similar function.

In an example, the targeting module 504 may select the target group of spectators by using a ticket type targeting in which different ticket categories can be used as a criterion to tailor messages, offers, and experiences to specific ticket holders. In another example, the targeting module 504 may select the target group of spectators using location-based targeting in which spectators situated in different areas of the racetrack can receive targeted information.

In yet another example, the targeting module 504 may select the target group of spectators by determining their interests, such as favorite racing teams or drivers, and deliver updates, statistics, and special content related to those preferences. In yet another example, the targeting module 504 may select the target group of spectators based on engagement level in which spectators who actively engage with the race even app or show a high level of interest by checking into different race locations can receive rewards or recognition for their participation.

In some implementations, the targeting module 504 may select the target group of spectators based on user demography in which criteria such as age, gender or language preference can be used to customize content and promotions. For instance, families with children might receive information about kid-friendly activities at the motorsport race.

In some implementations, the transmission module 506 may be configured to transmit the acquired ERD to the target group of spectators. In some implementations, the transmission module 506 includes a control subsystem 506a. The control subsystem may include a processor 506b, at least one database and 510 a computer readable memory 506c including a processor-readable instruction that is executed by the processor 506b and causes the processor 506b to transmit the acquired ERD to the target group of spectators.

In some implementations, the processor 506b, the computer readable memory 506c and the one or more database of the transmission module 506 may be any of the above-mentioned processor, memory and database used for the transmission module 506.

In an example, the transmission module 506 transmits the acquired ERD to the target group of spectators by delivering real-time commentary, race updates, and announcements to spectators in the stands, providing insights into the race, driver statistics, and event-related news.

In another example, the transmission module 506 may transmit the acquired ERD to the target group of spectators by using live audio where spectators can access live radio broadcasts or audio commentary on their smart phones or portable radios, allowing them to choose their preferred audio feed, including team radio communications.

In yet another example, the transmission module 506 may transmit the acquired ERD to the target group of spectators by providing live race coverage and in-car camera feeds on their smart phones or tablets. Different camera angles and driver-specific may feed can be offered for a more personalized experience.

In yet another example, the transmission module 506 may transmit the acquired ERD by using real-time leader boards and statistics, fan engagements apps, social media feeds, and fan zone information.

In some implementations, the engagement module 508 may allow the target group of spectators to interact with the motorsport race by using the MRRD to place parimutuel wagers about motorsport race outcomes. In some implementations, the engagement module 508 may include a control subsystem 508a. The control subsystem 508a includes a processor 508b, the least one database 510 and a computer readable memory 508c including a processor-readable instruction that is executed by the processor 508b and cause the processor 508c to interact with the motorsport race by using the MRRD, causing the spectators to have an enhanced spectator experience.

In some implementations, the processor 508b, the computer readable memory 508c and the one or more database 510 of the engagement module 508 may be any of the above-mentioned processor, memory and database used for explaining the communication subsystem 502.

In some implementations, the enhanced spectator experience may cause by the engagement module 508 is chosen from the group consisting of participants in the motorsport race, having an emotional experience during the motorsport race, enjoying the motorsport race more than they would have without the system 500, betting on the outcome of the motorsport race, or a combination of each of those things.

In some implementations, the engagement module 508 may allow the target group of spectators to interact with the motorsport race by placing pari-mutuel wagers on race outcomes which adds excitement and engagement to the motorsport race. In an example, a dedicated mobile app may allow spectators to place wagers on various race outcomes, such as the winner, podium winner, podium finishers, fastest lap, or the number of safety car period.

In another example, the engagement module 508 may allow interaction of the target group of spectators by providing a live betting platform where spectators can use a real-time betting platform to make dynamic wagers during the race, adjusting their bets as the race unfold.

In yet another example, the engagement module 508 may allow interaction of the target group of spectators providing driver performance betting such in which wagers can be placed on individual driver performance, such as predicting the number of overtakes, the driver with the most laps led, or who will finish as the top-ranked driver for a particular team. In yet another example, the engagement module 508 allows participation of the target group of spectators by using championship betting, safety car betting, driver head-to-head betting, and live betting challenges, in race betting contests, and social betting pools.

In some implementations, the system 500 may establish a two-way communication between the motorsport race and the spectator. The two-way communication allows the spectator to have enhanced engagement with the motorsport race.

In some implementations, the engagement module 508 may enable the target group of spectators to place parimutuel wagers on the finish order. In addition, the engagement module 508 may be configured to allow the target group of spectators to use the MRRD to place bets, including over and under ones, about aspects of a motorsport race chosen from the group consisting of the driver who had the lead for the most laps, the number of laps under a caution flag, the number of caution flags, the first driver to make a pit stop, the driver with the fastest pit stop, the driver that is first to crash, the length of the race, the winning car number, whether the winning car number is an odd or even number, the driver who leads the first lap, and the winning race team.

In some implementations, the system 500 further includes a data processing module configured to amalgamate and reformat the MRRD into a standardized data feed that is receivable by parimutuel platforms that provide real-time odds for betting based upon the analyzed data.

In some implementations, the allocation module 512 may be configured to designate and transmit to the event producer a portion of the parimutuel wagers. The allocation module 512 may include a control unit 512a, a processor 512b, a memory 512c and the one or more databases 512.

In some implementations, the processor 508b, the computer readable memory 508c and the one or more database 510 of the engagement module 508 may be any of the above-mentioned processor, memory and database used for explaining the communication subsystem 502.

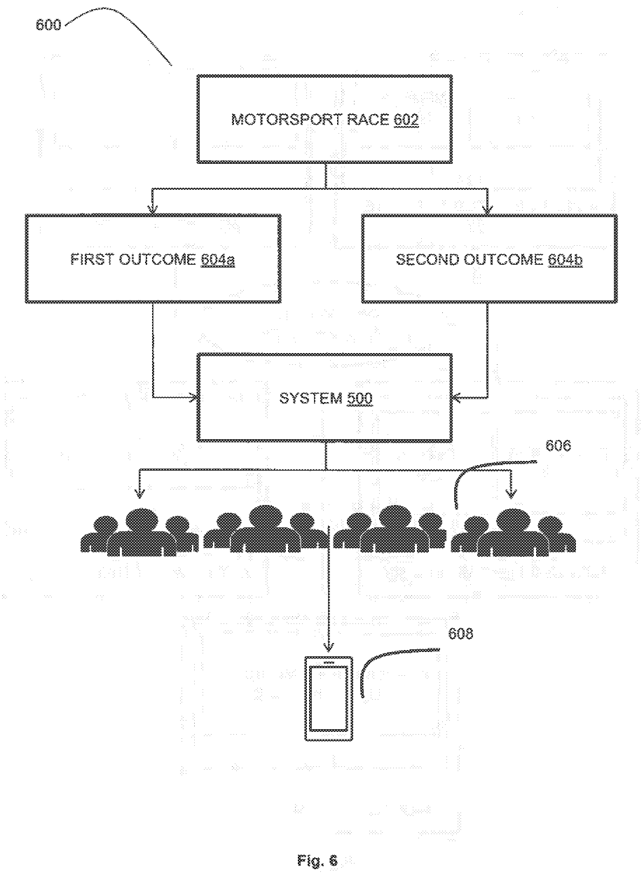

FIG. 6 is a block diagram 600 illustrating the communication between motorsport race 602 and a plurality of spectators 606 through the system 500, in accordance with an exemplary example implementation of the techniques of the disclosure. The event may include “n” outcomes, where n is a natural number. In an example, the event may include a first outcome 604a and a second outcome 604b.

In some implementations, the system 500 may provide wagers to the plurality of spectators 606 to engage with the motorsport race 602. The plurality of spectators 606 participates in the motorsport race 602 by applying on the outcomes of the motorsport race, where the outcome may be the first outcome 604a, the second outcome 204b up to the nth outcome of the motorsport race 602.

In some implementations, the plurality of spectators 606 may receive ongoing statistics related to the outcomes of the motorsport race 602 on their mobile phones 608. The mobile phones 608 may allow the plurality of spectators 606 to communicate with the motorsport race 602 through the mobile phone 608. The communication between the plurality of spectators 606 and the event 602 may be a two-way communication which enhances the motorsport race engagement.

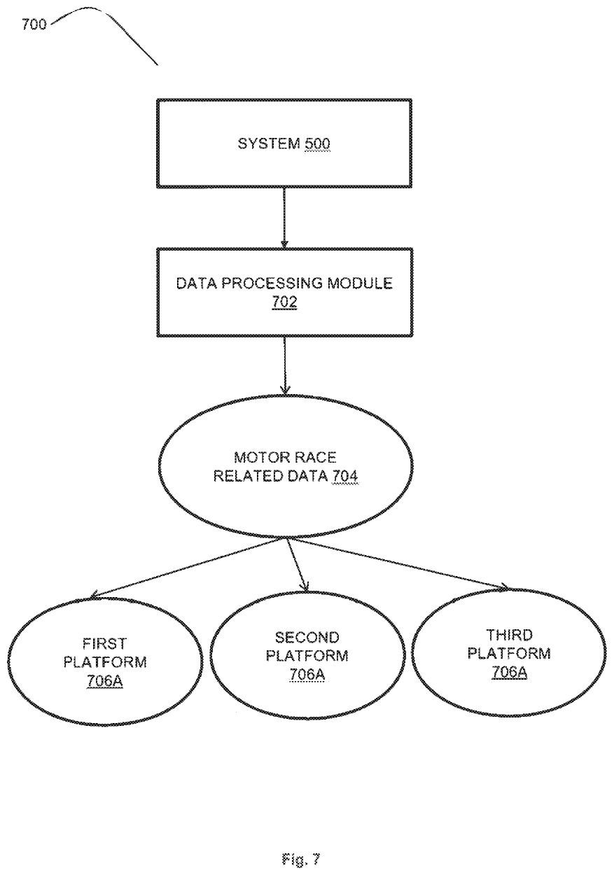

FIG. 7 illustrates a diagrammatic representation 700 illustrating a data processing module 702 configured to amalgamate and reformat the MRRD, in accordance with an example implementation of the techniques of the disclosure. The MRRD is amalgamated and reformatted into a standardized data feed that is receivable by a plurality of parimutuel platforms that provide real-time odds for betting based upon the analyzed data, in an exemplary example implementation of the techniques of the disclosure.

In some implementations, the plurality of parimutuel platforms that may receive the standardized data feed associated with the motorbike race related data include a first platform 706a, a second platform 706b, a third platform 706c and so on.

In some implementations, the first platform 706a may be a dedicated parimutuel platform designed to receive and process the standardized data feed for motorbike race-related data. In addition, the second platform 706b is any parimutuel platform configured to accept and utilize the standardized data feed for providing real-time odds for betting on motorbike races. Further, the third platform 706c is another parimutuel platform in the described embodiment, intended to receive and process the standardized data feed for motorbike race-related information. There may be more platforms beyond the specifically mentioned ones. The platforms collectively form part of the system designed to process and present real-time odds for betting based on the analyzed motorbike race data.

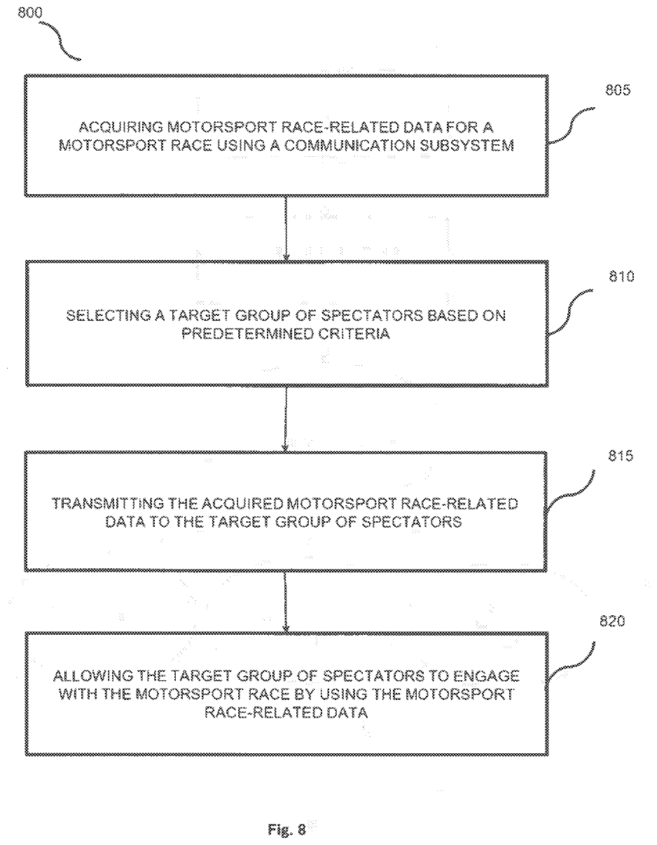

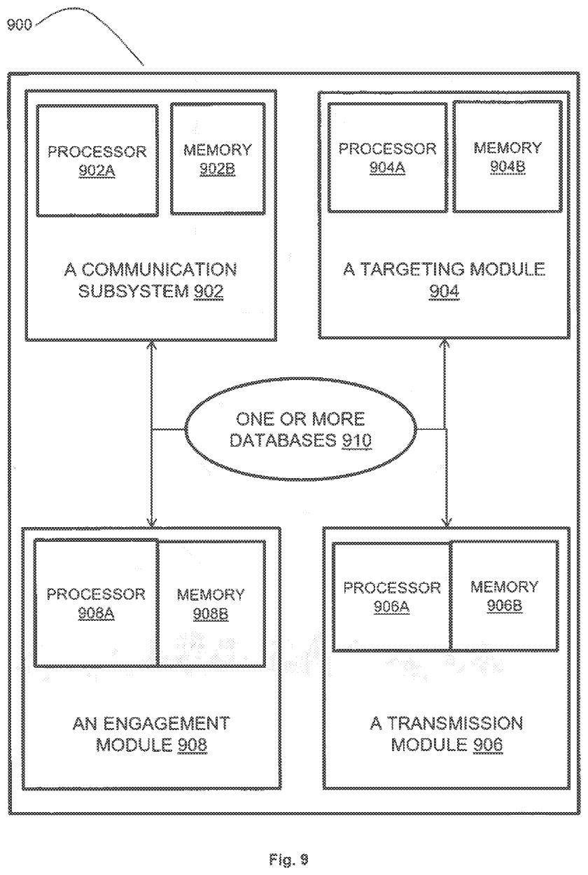

FIG. 8 is a block diagram illustrating a method 800 for enhancing the spectator experience during a motorbike race, in accordance with an example implementation of the techniques of the disclosure. In one specific embodiment, the flow chart 800 may include steps to illustrate the method for enhancing the spectator experience during the motorbike race. Other embodiments may include other steps to illustrate similar method.

In some implementations, the method initiates step 805 and terminates at step 820. At step 805, the method 800 may include acquiring a motorbike race related data (MRRD) for the motorbike race using a communication subsystem 502 (References have been made to FIG. 5).

In addition, the step 805 may also include acquiring transmission signals of live motorsport races, chosen from the group consisting of broadcast and streaming signals. Further, the step 805 includes using the communication subsystem 502 with at least one sensor for real-time data acquisition of motorsport races.

At step 810, a target group of spectators may be selected based on a predetermined criterion. In some implementations, the predetermined criteria for selecting the target group of spectators includes at least one of geographical location, user preferences, and user demographics. In another example implementation of the techniques of the disclosure, the predetermined criteria may or may not include other parameters performing similar function.

At step 815, the acquired MRRD may be transmitted to the target group of spectators. At step 820, the target group of spectators are allowed to engage with the motorbike race by using the MRRD to place parimutuel wagers about motorsport race outcomes, causing the spectators to have an enhanced spectator experience.

In some implementations, the enhanced spectator experience caused by the allowing step 820 may be chosen from the group consisting of participants in the motorbike race. The participants have an emotional experience during the motorbike race, enjoying the event more than they would have without the system 400, betting on the outcome of the motorbike race, or a combination of each of those things.

In some implementations, the step 820 of allowing the target group of spectators to engage with the motorbike race includes placing wagers on various motorbike race outcomes chosen from the group consisting of final times, final scores, driver statistics, player statistics, specific race events, and specific game events. In another example implementation of the techniques of the disclosure, the group of various motorbike race outcomes may include any other parameters relates to a specific game.

In some implementations, the method 800 further includes amalgamating and reformatting the MRRD into a standardized data feed that is receivable by parimutuel platforms that provide real-time odds for betting based upon the analyzed data.

In an exemplary example implementation of the techniques of the disclosure, a computer-readable medium includes computer-executable instructions for implementing the method for enhancing spectator experience during an event. In an example, the computer readable medium is but not limited to a memory card which can store software and instructions, CD-ROM that can be read by a computer's optical drive, DVD, USB Flash Drive, Hard Disk Drive to store both data and execute instructions, Solid State Drive, Magnetic Tape, Cloud Storage in which files and instructions are stored like Google Drive or drop box, network storage, remote repositories, ROM, EPROM and EEPROM.

FIG. 9 is a flow chart 900 illustrating a system for enhancing spectator experience during an auction, in accordance with an example implementation of the techniques of the disclosure. The system 900 is configured for use in relation to the auction conducted by an auction house. In addition, the auction may include at least one offer to bidders of an item for sale and at least one unknown outcome for the at least one offer.

Further, the auction produces a known outcome (there may or may not be a winning bid). The system 900 may be configured for identifying the at least one unknown outcome to a target group prior to the bidding and for reporting to the target group of spectators the known outcome at conclusion of the bidding. Furthermore, the system 900 may be further configured for assessing a level of spectator engagement with the auction prior to the conclusion of the bidding

In a specific embodiment, the system 900 may include a communication subsystem 902, a targeting module 904, a transmission module 906 and an engagement module 908. Other implementations of the techniques of the disclosure may or may not include other modules to implement the techniques.

In some implementations, the communication subsystem 902 is configured to acquire auction-related data (ARD) associated with the auction and an estimated successful bid amount. The ARD may include the at least one offer of the item for sale and the at least one unknown outcome for the item for sale. In addition, the ARD comes from various auctions related to the auction.

In some implementations, the auction may be chosen from the group consisting of automobiles, motorcycles, watercraft, aircraft, furniture, real estate, art, antiquities, jewelries, firearms, animals (horses, bulls), and collectibles such as coins, stamps, comic books, antique furniture, artwork, watches and posters. In some implementations, the ARD may be acquired by the communication subsystem 902 includes information related to auction items, such as descriptions, values, and current bid status.

In some implementations, the communication subsystem 902 may include a control subsystem 902a. The control subsystem 902a includes a processor 902b, at least one database 910 and a computer readable memory 902c may be including a processor-readable instruction that is executed by the processor 902b and cause the processor 902b to acquire the auction-related data (ARD) for the auction. The computer readable memory 902c in the control subsystem 902a is used to store the ARD.

The processor 902b associated with the control subsystem 902a may be any well-known processor, but not limited to processors from Intel Corporation. Alternatively, the processor 902b may be a dedicated controller such as an ASIC or ARM, MIPS, SPARC, or INTEL® IA-32 microcontroller.

Similarly, in yet another example implementation of the techniques of the disclosure, the processor 902b may comprise a collection of processors which may or may not operate in parallel. The processor 902b may be any processor-driven device, such as may include one or more microprocessors and memories or other computer-readable media operable for storing and executing computer-executable instructions. Examples of processor-driven devices may include, but are not limited to, a server computer, a mainframe computer, one or more networked computers, a desktop computer, a personal computer, an application-specific circuit, a microcontroller, a minicomputer, or any other processor-based device.

Also, the processor 902b may execute any set of instructions directly as computer executable codes or indirectly (such as scripts). In that regard, the terms “instructions,” and “steps” may be used interchangeably herein. The instructions may be stored in object code form for direct processing by the processor 902b, or in any other computer language including scripts or collections of independent source code modules that are interpreted on demand or compiled in advance.

In accordance with an example implementation of the techniques of the disclosure, the computer readable memory 902c may be configured with the processor for storing the ERD. For example, the computer readable memory 902c may store software used by a user interface or the processor, such as an operating system (not shown), application programs (not shown), and an associated internal database (not shown).

In addition, the computer readable memory 902c associated with the control subsystem 902a stores instructions to be executed by the control subsystem 902a. The computer readable memory 920c can be any type of suitable memory, including various types of dynamic random-access memory (DRAM) such as SDRAM, various types of static RAM (SRAM), and various types of non-volatile memory (PROM, EPROM, and flash). It should be understood that the computer readable memory 902c may be a single type of memory component or it may be composed of many different types of memory components. As noted above, the computer readable memory 902c stores instructions for executing one or more methods for enhancing spectator experience during an auction. For example, the computer readable memory may store software used by the user device, such as an operating system (not shown), application programs (not shown), and an associated internal database (not shown). In an alternative embodiment, the computer readable memory 902c may be an external memory to the control subsystem 902a to store various data and computer executable instructions.

In some embodiments, the computer readable memory 902c may communicate with the processor(s) via a system bus. It may include one or more non transitory storage units and one or more optional removable non transitory storage units that may include interfaces or device controllers (not shown) communicably coupled between non transitory storage unit and the system bus, as is known by those skilled in the relevant art. The non transitory storage units, and their associated storage devices provide non-volatile storage of computer-readable instructions, data structures, program modules and other data for the processor. Those skilled in the relevant art will appreciate that other types of storage devices may be employed to store digital data accessible by a computer, such as magnetic cassettes, flash memory cards, RAMs, ROMs, smart cards, etc.

As an example, and not by way of limitation, the computer readable memory 902c may comprise one or more non-transitory storage mediums. Such non-transitory storage medium may include, but is not limited to, any current or future developed persistent storage device. Such persistent storage devices may include, without limitation, magnetic storage devices such as hard disc drives, electromagnetic storage devices such as memristors, molecular storage devices, quantum storage devices, electrostatic and storage devices such as solid-state drives.

In some implementations, the communication subsystem 902 may include one or more sensors (not shown in figures) for real-time data acquisition of the auction. In an example, the one or more sensors may be placed around the auction venue to monitor environmental conditions such as temperature, humidity, and wind speed. In accordance with an example implementation of the techniques of the disclosure, the data from the one or more sensors is transmitted to the target group of spectators.

In some implementations, the communication subsystem 902 may be configured to acquire transmission signals of live auction, chosen from the group consisting of broadcast and streaming signals. In an example, the communication subsystem 902 may be wired or wireless. The wired communication may include any of but not limited to landline phones which uses copper wires transmit voice signals and fibre-optic communication which transmits data using light signals through optical fibres. The wireless communication includes but not limited to Wi-Fi which allows devices to connect through the internet and communicate wirelessly and Bluetooth which is used for short-range connections between devices like headphones and smart phones. In addition, the communication subsystem 902 is but not limited to a plurality of smart phones which use cellular networks to transmit voice, text messages, and data and a plurality of cell towers which use relay signals from the phones to the network.

In another example, the communication subsystem 902 may be a telemetry system which allows for real-time analysis and decision-making during the auction. In yet another example, the communication system 902 may include cameras mounted on race cars in case the auction is based on a race event, to capture video footage, which is streamed to the race control center and broadcasted to the fans. In yet another example, the communication system 902 may integrate with timing and scoring equipment to provide precise information about lap times, sector times and race positions to teams, race control and spectators in case of a race event. In yet another example, the communication system 902 may include any team communication networks and data distribution to spectators. The above-mentioned examples illustrate that a communication system can be configured to acquire, process, and distribute ARD to various spectators, enhancing the auction experience and ensuring the safety and efficiency of auction events.

In addition, the communication subsystem 902 may include one or more sensors (not shown in figures) for real-time data acquisition of the auction. In some implementations, the communication subsystem 902 is configured to acquire transmission signals of live auction, chosen from the group consisting of broadcast and streaming signals.

In some implementations, the targeting module 904 may be configured to select a target group of spectators based on a predetermined criterion. In some implementations, the predetermined criteria for selecting the target group of spectators includes at least one of user preferences, user demographics, and previous betting behavior. In another example implementation of the techniques of the disclosure, the predetermined criterion may or may not include other parameters performing similar function.

In some implementations, the targeting module 904 includes a control subsystem 904a. The control subsystem 904a includes a processor 904b, the least one database 910 and a computer readable memory 904c including a processor-readable instruction that is executed by the processor 904b and cause the processor 904b to select the target group of spectators based on the predetermined criterion. The computer readable memory 904c in the control subsystem 904a is used to store the target group of spectators.

In some implementations, the processor 904b, the computer readable memory 904c and the one or more database 910 of the targeting module 904 may be any of the above-mentioned processor, memory and database used for the communication subsystem 902.

In some implementations, the predetermined criteria for selecting the target group of spectators includes at least one of geographical location, user preferences, and user demographics. In another example implementation of the techniques of the disclosure, the predetermined criterion may or may not include other parameters performing similar function.

In an example, the targeting module 904 may select the target group of spectators by using a ticket type targeting in which different ticket categories can be used as a criterion to tailor messages, offers, and experiences to specific ticket holders. In another example, the targeting module 904 may select the target group of spectators using location-based targeting in which spectators situated in different areas of the auction can receive targeted information.

In yet another example, the targeting module 904 may select the target group of spectators by determining their interests, such as favorite racing teams or drivers, and deliver updates, statistics, and special content related to those preferences. In yet another example, the targeting module 904 may select the target group of spectators based on engagement level in which spectators who actively engage with the auction app or show a high level of interest by checking into different auction locations can receive rewards or recognition for their participation.

In some implementations, the targeting module 904 may select the target group of spectators based on user demography in which criteria such as age, gender or language preference can be used to customize content and promotions. For instance, families with children might receive information about kid-friendly activities at the auction.

In some implementations, the transmission module 906 is configured to transmit the acquired ARD to the target group of spectators. In some implementations, the transmission module 906 includes a control subsystem 906a. The control subsystem includes a processor 906b, the least one database 910 and a computer readable memory 906c including a processor-readable instruction that is executed by the processor 906b and causes the processor 506c to transmit the acquired ERD to the target group of spectators.

In some implementations, the processor 906b, the computer readable memory 906c and the one or more database 910 of the transmission module 906 may be any of the above-mentioned processor, memory and database used for the transmission module 906.

In an example, the transmission module 906 may transmit the acquired ERD to the target group of spectators by delivering real-time commentary, auction updates, and announcements to spectators in the stands, providing insights into the auction, driver statistics, and auction-related news.

In another example, the transmission module 906 may transmit the acquired ERD to the target group of spectators by using live audio where spectators can access live radio broadcasts or audio commentary on their smart phones or portable radios, allowing them to choose their preferred audio feed, including team radio communications.

In yet another example, the transmission module 506 may transmit the acquired ERD to the target group of spectators by providing live auction coverage and in-car camera feeds on their smart phones or tablets. Different camera angles and driver-specific feeds can be offered for a more personalized experience.

In yet another example, the transmission module 906 may transmit the acquired ERD by using real-time leader boards and statistics, fan engagements apps, social media feeds, and fan zone information.

In some implementations, the engagement module 908 may allow the target group of spectators to interact with the auction by using the ARD to place bets associated with auction-bid outcomes. In some implementations, the enhanced spectator experience caused by the engagement module is chosen from the group consisting of participants in the auction, having an emotional experience during the auction, enjoying the auction more than they would have without the system 900, betting on the outcome of the auction, or a combination of each of those things.

Further, the engagement module 908 may allow the target group of spectators to place bets on the successful-bid amount in real-time, with the option to increase their bets during the auction. In some implementations, the system 900 may further include a data processing module (not shown in figures) configured to analyze the ARD and provide real-time successful-bid odds based on the analyzed data, including current auction item values and bid histories.

In some implementations, the engagement module 908 may include a control subsystem 908a. The control subsystem 908a includes a processor 908b, the least one database 910 and a computer readable memory 908c including a processor-readable instruction that is executed by the processor 908b and cause the processor 908c to interact with the motorsport race by using the ERD, causing the spectators to have an enhanced spectator experience.

In some implementations, the processor 908b, the computer readable memory 908c and the one or more database 910 of the engagement module 908 may be any of the above-mentioned processor, memory and database used for the communication subsystem 902.

In an example, a dedicated mobile app may allow spectators to place wagers on various auction outcomes, such as the winner, podium winner, podium finishers, fastest lap, or the number of safety car period.

In another example, the engagement module 908 may allow interaction of the target group of spectators by providing a live betting platform where spectators can use a real-time betting platform to make dynamic wagers during the auction, adjusting their bets as the auction unfold.

In yet another example, the engagement module 908 may allow interaction of the target group of spectators providing auction in which wagers can be placed on individual driver performance in case of a race event, such as predicting the number of overtakes, the driver with the most laps led, or who will finish as the top-ranked driver for a particular team.

In yet another example, the engagement module 908 may allow participation of the target group of spectators by using championship betting, safety car betting, driver head-to-head betting, live betting challenges, in race betting contests, and social betting pools, in case of an auction on a competitive event such as racing.

In some implementations, the system 900 may establish a two-way communication between the motorsport race and the spectator. The two-way communication may allow the spectator to have enhanced engagement with the auction.

In some implementations, the engagement module 908 may enable the target group of spectators to place parimutuel wagers on the finish order. In addition, the engagement module 908 may be configured to allow the target group of spectators to use the ARD to place bets, including over and under ones, about aspects of an auction chosen from the group consisting of the driver who had the lead for the most laps in case of a racing event, the number of laps under a caution flag, the number of caution flags, the first driver to make a pit stop, the driver with the fastest pit stop, the driver that is first to crash, the length of the race, the winning car number, whether the winning car number is an odd or even number, the driver who leads the first lap, and the winning race team.

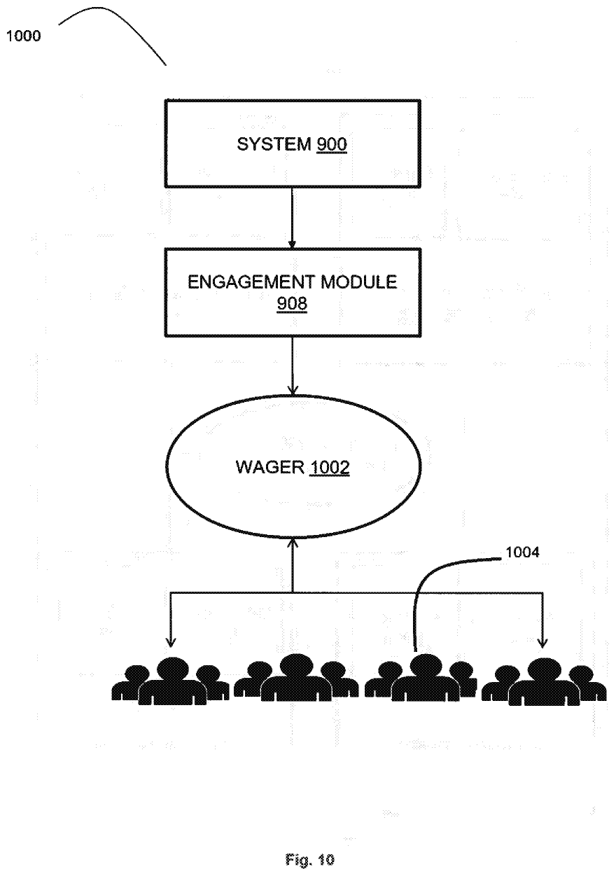

FIG. 10 is a diagrammatic representation 1000 of the engagement module 908 associated with the system 900, in accordance with an exemplary example implementation of the techniques of the disclosure (References have been made to FIG. 9). The engagement module 908 measures the level of spectator engagement by offering wagers to a target group of spectators 1004 and collecting wagers 1002 from the target group of spectators 1004.

In some implementations, the engagement module 908 may provide to the target group of spectators 1004, prior to the bidding, an estimated successful bid amount. Further, the engagement module 908 may provide at least one update to the estimated successful bid amount to the target group of spectators 1004 during the bidding. The engagement module 908 may offer wagers 1002 to the target group of spectators based on the estimated successful bid amount.

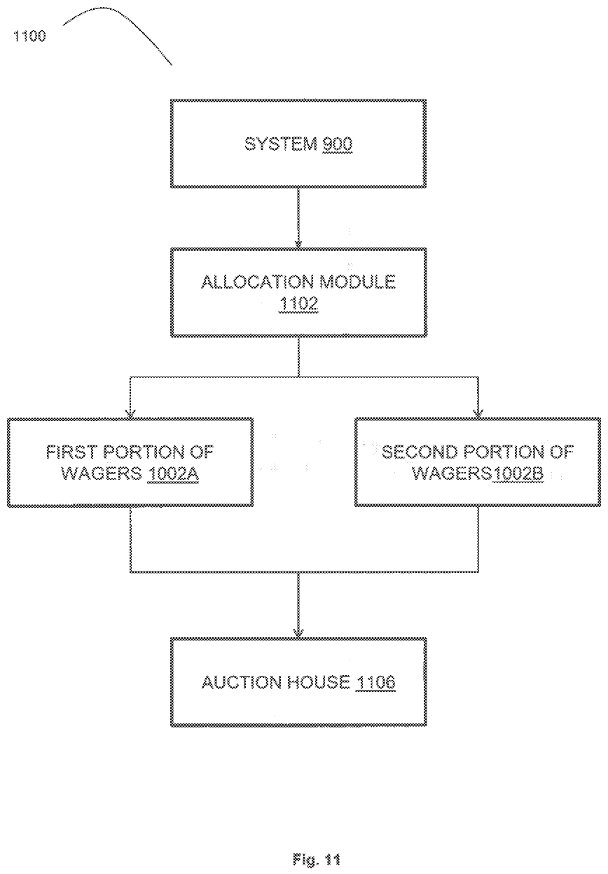

FIG. 11 is a diagrammatic representation 1100 of an allocation module 1102 associated with the system 900, in accordance with an exemplary example implementation of the techniques of the disclosure. The allocation module 1102 may be configured to designate and transmit a portion of the wagers 1002 to the auction house 1106 (References have been made to FIG. 10).

In an example, the allocation module 1102 may allocate a first portion of the wagers 1002a and a second portion of the wagers 1002b to the auction house 1106. In another example, the allocation module 1102 “n” portion of the wagers to the auction house 1106, where “n” is a natural number.

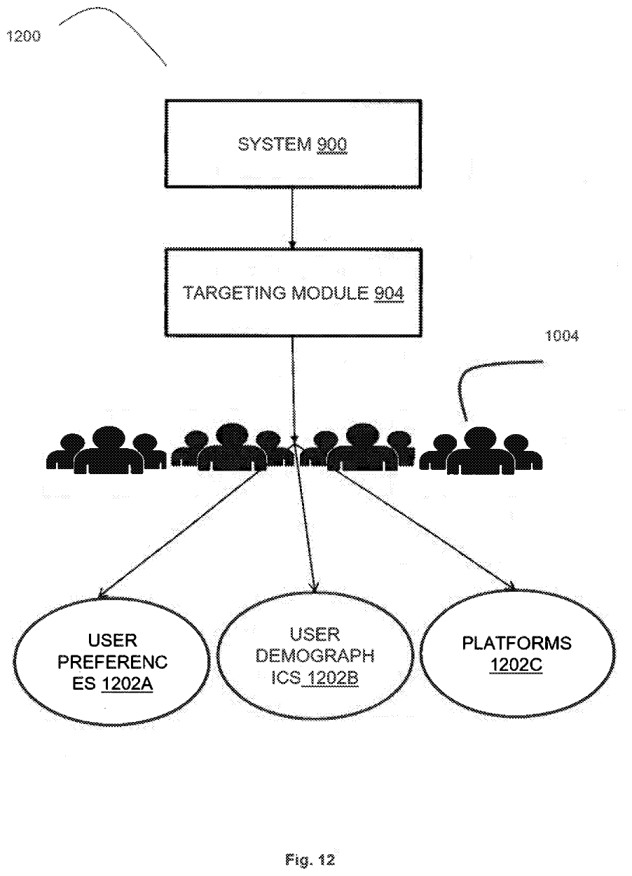

FIG. 12 is a diagrammatic representation 1200 illustrating the targeting module 904 associated with the system 900, in accordance with an exemplary example implementation of the techniques of the disclosure. The targeting module 904 may be configured to select the target group of spectators 1004. In some implementations, the target group of spectators are selected based on a predetermined criterion. The predetermined criterion may include a plurality of user preferences 1202a, a plurality of user demographics 1202b and a plurality of platforms 1202c.

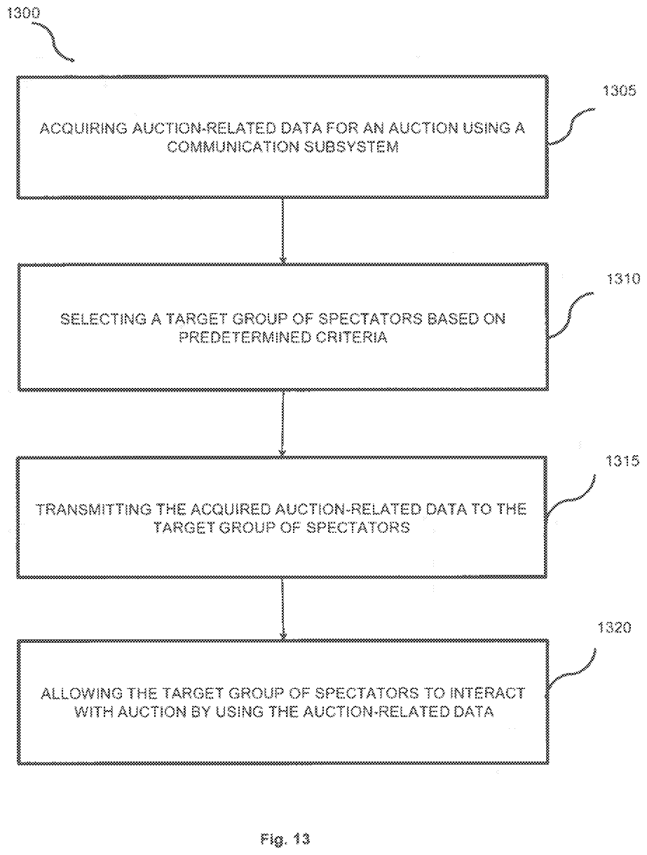

FIG. 13 is a flow chart 1300 illustrating a method for enhancing the spectator experience during an auction, in accordance with an example implementation of the techniques of the disclosure. In some implementations, the auction is chosen from the group consisting of automobiles, motorcycles, watercraft, aircraft, furniture, and collectibles. In one specific embodiment, the flow chart 1300 may include steps to illustrate the aforementioned method for enhancing the spectator experience during the auction. Other embodiments may include other steps to illustrate similar method.

In some implementations, the method may initiate step 1305 and terminates at step 1320. At step 1305, an auction-related data (ARD) associated with the auction and an estimated successful bid amount is acquired using a communication subsystem 902 (References have been made to FIG. 9). In some implementations, the acquired ARD includes information related to auction items, such as descriptions, values, current bid status, previous and other auction results.

At step 1310, a target group of spectators may be selected based on predetermined criteria. In some implementations, the step of selecting 1310 the target group of spectators is based on predetermined criteria, including user preferences, user demographics, and previous betting behavior.

At step 1315, the acquired ARD may be transmitted to a target group of spectators. At step 1320, the target group of spectators may be allowed to interact with the auction by using the ARD to place bets associated with auction-bid outcomes. In some implementations, the step 1320 of allowing the target group of spectators to place bets on the successful-bid amount in real-time, with the option to increase their bets during the auction.

In some implementations, the method may further include a step of analyzing the ARD and provides real-time successful-bid odds based on the analyzed data, including current auction item values, and bid histories.

In some implementations, a computer-readable medium includes computer-executable instructions for implementing the method for enhancing spectator experience during an auction. In an example, the computer readable medium is but not limited to a memory card which can store software and instructions, CD-ROM that can be read by a computer's optical drive, DVD, USB Flash Drive, Hard Disk Drive to store both data and execute instructions, Solid State Drive, Magnetic Tape, Cloud Storage in which files and instructions are stored like Google Drive or dropbox, network storage, remote repositories, ROM, EPROM and EEPROM.

In yet another embodiment of the present invention, a method for wagering for an auction event is provided, the auction event comprising at least one offer to bidders of an item for sale and at least one unknown outcome for the at least one offer. At least one unknown outcome is identified to a target group prior to the start of bidding on the item for sale. Funds are received for a plurality of wagers for the at least one unknown outcome and a fund pool is generated based on the funds received for the at least one unknown outcome. The method further comprises receiving dynamic wagers for the item for sale and providing real-time bid odds based on the auction-related data. ARD is then received for the item for sale and transmitted to the target group, the ARD comprising at least one known outcome for the item for sale. The ARD comprises data such as real-time commentary, real-time bidding updates, the hammer price for the auctioned item, and announcements to spectators at the auction event.

Portions of the fund pool are then allocated based, at least in part, on the received ARD. For example, the allocation may be based, at least in part, on the wager amount for the at least one unknown outcome. The allocation may be based, at least in part, on the odds associated with the wager for the at least one unknown outcome. The allocation may be based, at least in part, on the wager type for the at least one unknown outcome. The wager type may be, for example, an over/under wager based on a number set by a third party, such as, for example, the auction house promoting the auction event. One example of a wager type is a prediction of the exact hammer price for the auctioned item. Another example of a wager type is a prediction of the hammer price for the auctioned item within a specific percentage range (such as, without limitation +/−1%, +/−2%, +/−3%, +/−4%, +/−5%, +/−6%, +/−7%, +/−8%, +/−9%, +/−10%, etc.). Another example of a wager type is a prediction of the total final hammer price for a specified combination of items being auctioned (such as, without limitation, 2 items, 3 items, 4 items, 5 items, 6 items, 7 items, 8 items, 9 items, 10 items, etc.). Yet another example of a wager type is a prediction of the total final hammer price for a specified combination of items within a specific percentage range (such as, without limitation +/−1%, +/−2%, +/−3%, +/−4%, +/−5%, +/−6%, +/−7%, +/−8%, +/−9%, +/−10%, etc.).

The allocating step may include a first portion of the fund pool awarded to one or more persons that placed a wager for the item for sale. The allocating step may include a second portion of the fund pool awarded to an operator of a wagering service. The allocating step may include a third portion of the fund pool awarded to a jurisdictional regulatory gaming agency. The allocating step may include a third portion of the fund pool awarded to the auction house promoting the auction event.

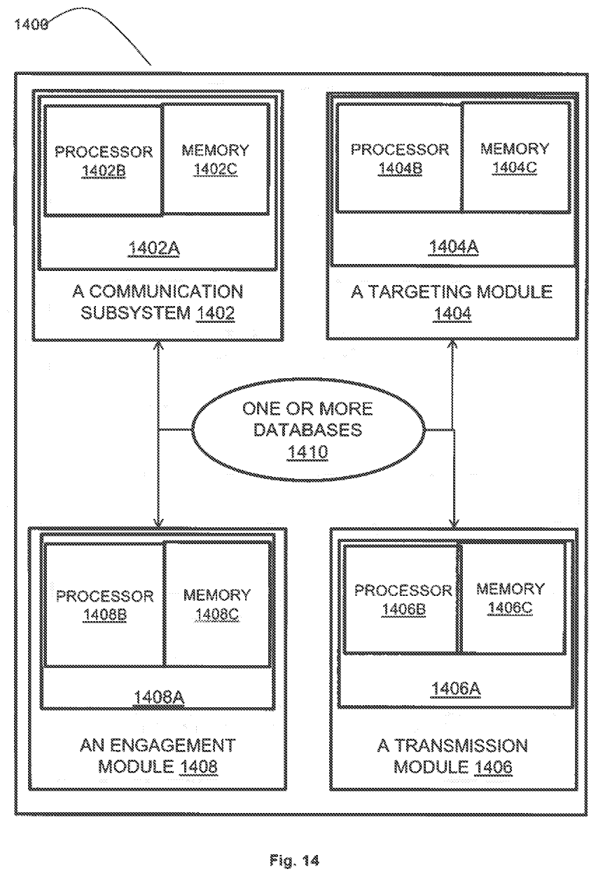

FIG. 14 is a block diagram illustrating a system 1400 for enhancing spectator experience during an animal event produced by an event producer, in accordance with an example implementation of the techniques of the disclosure. The animal event may be occurring between a beginning time and a completion time and producing one or more categories of interim outcomes between the beginning time up to the completion time.

The interim outcomes are unknown prior to the beginning time, the system may be configured for identifying the one or more categories of interim outcomes to a target group of spectators. The system 1400 further configured for reporting to the target group of spectators in a period between the beginning time and the completion time the interim outcomes as they become known during the event, and for measuring a level of spectator engagement with the animal event.

In some implementations, the animal event may be chosen from the group consisting of rodeos, stock shows, bullfights, and circuses. In a specific embodiment, the system 1400 includes a communication subsystem 1402, a targeting module 1404, a transmission module 1406 and an engagement module 1408. Other implementations of the techniques of the disclosure may or may not include other modules to implement the techniques.

In some implementations, the communication subsystem 1402 may be configured to acquire animal-event-related data (AERD) for the animal event. The communication subsystem 1402 may further includes one or more sensors (not shown in figures) for real-time data acquisition of the animal event.

In some implementations, the communication subsystem 1402 may include a control subsystem 1402a. The control subsystem includes a processor 1402b, at least one database 1410 and a computer readable memory 1402c including a processor-readable instruction that is executed by the processor 1402b and may cause the processor 1402b to acquire the animal event-related data (AERD) for the animal event. In some implementations, the AERD may include the one or more categories of interim outcomes before the beginning time of the event and the interim outcomes as they become known during the event.

The computer readable memory 1402c in the control subsystem 1402a is used to store the AERD. The processor 1402b associated with the control subsystem 1402a may be any well-known processor, but not limited to processors from Intel Corporation. Alternatively, the processor may be a dedicated controller such as an ASIC or ARM, MIPS, SPARC, or INTEL® IA-32 microcontroller.

Similarly, in yet another example implementation of the techniques of the disclosure, the processor 1402b may comprise a collection of processors which may or may not operate in parallel. The processor 1402b may be any processor-driven device, such as may include one or more microprocessors and memories or other computer-readable media operable for storing and executing computer-executable instructions. Examples of processor-driven devices may include, but are not limited to, a server computer, a mainframe computer, one or more networked computers, a desktop computer, a personal computer, an application-specific circuit, a microcontroller, a minicomputer, or any other processor-based device.

Also, the processor 1402b may execute any set of instructions directly as computer executable codes or indirectly (such as scripts). In that regard, the terms “instructions,” and “steps” may be used interchangeably herein. The instructions may be stored in object code form for direct processing by the processor 1402b, or in any other computer language including scripts or collections of independent source code modules that are interpreted on demand or compiled in advance.

In accordance with an example implementation of the techniques of the disclosure, the computer readable memory 1402c may be configured with the processor for storing the ERD. For example, the computer readable memory 1402c may store software used by a user interface or the processor, such as an operating system (not shown), application programs (not shown), and an associated internal database (not shown).

In addition, the computer readable memory 1402c associated with the control subsystem 1402a stores instructions to be executed by the control subsystem 1402a. The computer readable memory 1402c can be any type of suitable memory, including various types of dynamic random-access memory (DRAM) such as SDRAM, various types of static RAM (SRAM), and various types of non-volatile memory (PROM, EPROM, and flash). It should be understood that the computer readable memory 102c may be a single type of memory component or it may be composed of many different types of memory components. As noted above, the computer readable memory 1402c stores instructions for executing one or more methods for enhancing spectator experience during the animal event. For example, the computer readable memory 1402c may store software used by the user device, such as an operating system (not shown), application programs (not shown), and an associated internal database (not shown). In an alternative embodiment, the computer readable memory 1402c may be an external memory to the control subsystem 1402a to store various data and computer executable instructions.

In some embodiments, the computer readable memory 1402c may communicate with the processor(s) via a system bus. It may include one or more non transitory storage units and one or more optional removable non transitory storage units that may include interfaces or device controllers (not shown) communicably coupled between non transitory storage unit and the system bus, as is known by those skilled in the relevant art. The non-transitory storage units, and their associated storage devices provide non-volatile storage of computer-readable instructions, data structures, program modules and other data for the processor. Those skilled in the relevant art will appreciate that other types of storage devices may be employed to store digital data accessible by a computer, such as magnetic cassettes, flash memory cards, RAMs, ROMs, smart cards, etc.

As an example, and not by way of limitation, the computer readable memory 702c may comprise one or more non-transitory storage mediums. Such non-transitory storage medium may include, but is not limited to, any current or future developed persistent storage device. Such persistent storage devices may include, without limitation, magnetic storage devices such as hard disc drives, electromagnetic storage devices such as memristors, molecular storage devices, quantum storage devices, and electrostatic storage devices such as solid-state drives.

In some implementations, the communication subsystem 1402 may include one or more sensors (not shown in figures) for real-time data acquisition of the animal event. In an example, the one or more sensors may be placed around the event track to monitor environmental conditions such as temperature, humidity and wind speed, track condition such as grip levels and debris, safety status. In accordance with an example implementation of the techniques of the disclosure, the data from the one or more sensors is transmitted to the target group of spectators.

In some implementations, the communication subsystem 1402 may be configured to acquire transmission signals of live animal events, chosen from the group consisting of broadcast and streaming signals. In an example, the communication subsystem 1402 may be wired or wireless. The wired communication includes but not limited to landline phones which uses copper wires transmit voice signals and fibre-optic communication which transmits data using light signals through optical fibres. The wireless communication includes but not limited to Wi-Fi which allows devices to connect through the internet and communicate wirelessly and Bluetooth which is used for short-range connections between devices like headphones and smart phones. In addition, the communication subsystem 1402 is but not limited to a plurality of smart phones which use cellular networks to transmit voice, text messages, and data and a plurality of cell towers which use relay signals from the phones to the network.

In another example, the communication subsystem 1402 may be a telemetry system which allows for real-time analysis and decision-making during the animal event in which animals are equipped with the telemetry system that continuously transmit MRRD, including engine performance, speed, tire condition, fuel levels, and driver biometrics, back to the team's pit area which allows for real-time analysis and decision-making during the animal event.

In yet another example, the communication system 1402 may include cameras mounted on animals to capture video footage, which is streamed to the animal event control center and broadcasted to the fans. In yet another example, the communication system 1402 may integrate with timing and scoring equipment to provide precise information about lap times, sector times and race positions to teams, race control and spectators.

In yet another example, the communication system 1402 may include any of trackside sensors, GPS tracking, race data analysis tools, driver biometrics, team communication networks and data distribution to spectators. The above-mentioned examples illustrate that a communication system can be configured to acquire, process, and distribute animal event-related data (AERD) to various spectators, enhancing the racing experience and ensuring the safety and efficiency of animal events.

In some implementations, the targeting module 1404 is configured to select a target group of spectators based on a predetermined criterion. In addition, the target group of spectators is selected before the beginning time of the animal event and during the animal event. In some implementations, the predetermined criteria for selecting the target group of spectators includes at least one of geographical location, user preferences, and user demographics.

In some implementations, the targeting module 1404 includes a control subsystem 1404a. The control subsystem 1404a includes a processor 1404b, the least one database 1410 and a computer readable memory 1404c including a processor-readable instruction that is executed by the processor 1404b and cause the processor 1404b to select the target group of spectators based on the predetermined criterion. The computer readable memory 1404c in the control subsystem 1404a is used to store the target group of spectators.

In some implementations, the processor, the computer readable memory 1404c and the one or more database 1410 of the targeting module 1404 may be any of the above-mentioned processor, memory and database used for the communication subsystem 1402.

In some implementations, the predetermined criteria for selecting the target group of spectators includes at least one of geographical location, user preferences, and user demographics. In another example implementation of the techniques of the disclosure, the predetermined criterion may or may not include other parameters performing similar function.

In an example, the targeting module 1404 may select the target group of spectators by using a ticket type targeting in which different ticket categories can be used as a criterion to tailor messages, offers, and experiences to specific ticket holders. In another example, the targeting module 1404 may select the target group of spectators using location-based targeting in which spectators situated in different areas of the racetrack can receive targeted information.

In yet another example, the targeting module 1404 may select the target group of spectators by determining their interests, such as favorite animal event teams or drivers, and deliver updates, statistics, and special content related to those preferences. In yet another example, the targeting module 1404 may select the target group of spectators based on engagement level in which spectators who actively engage with the animal event even app or show a high level of interest by checking into different race locations can receive rewards or recognition for their participation.

In some implementations, the targeting module 1404 may select the target group of spectators based on user demography in which criteria such as age, gender or language preference can be used to customize content and promotions. For instance, families with children might receive information about kid-friendly activities at the animal event.

In some implementations, the transmission module 1406 may be configured to transmit the acquired AERD to the target group of spectators. In some implementations, the transmission module 1406 includes a control subsystem 1406a. The control subsystem includes a processor 1406b, the least one database 1410 and a computer readable memory 1406c including a processor-readable instruction that is executed by the processor 1406b and causes the processor 1406b to transmit the acquired AERD to the target group of spectators.

In some implementations, the processor 1406b, the computer readable memory 1406c and the one or more database 1410 of the transmission module 1406 may be any of the above-mentioned processor, memory and database used for the transmission module 1406.

In an example, the transmission module 1406 transmits the acquired AERD to the target group of spectators by delivering real-time commentary, race updates, and announcements to spectators in the stands, providing insights into the race, driver statistics, and event-related news.

In another example, the transmission module 1406 transmits the acquired AERD to the target group of spectators by using live audio where spectators can access live radio broadcasts or audio commentary on their smart phones or portable radios, allowing them to choose their preferred audio feed, including team radio communications.

In yet another example, the transmission module 1406 transmits the acquired AERD to the target group of spectators by providing live animal event coverage and in-car camera feeds on their smart phones or tablets. Different camera angles and driver-specific feeds can be offered for a more personalized experience.

In yet another example, the transmission module 1406 transmits the acquired AERD by using real-time leader boards and statistics, fan engagements apps, social media feeds, and fan zone information.

In some implementations, the engagement module 1408 allows the target group of spectators to interact with the animal event by using the AERD to place bets about animal-event outcomes. In some implementations, the engagement module 1408 enables the target group of spectators to place bets on various animal-event outcomes chosen from the group consisting of final times, animal-trainer statistics, animal statistics, and specific event outcomes. In addition, the engagement module 1408 measures the level of spectator engagement.

In some implementations, the system 1400 further includes a data-processing module configured to analyze the AERD and provide real-time odds for betting on animal-event outcomes based on the analyzed data.

In some implementations, the engagement module 1408 may include a control subsystem 1408a. The control subsystem 1408a may include a processor 1408b, the least one database 1410 and a computer readable memory 1408c including a processor-readable instruction that is executed by the processor 1408b and may cause the processor 1408b to interact with the animal event by using the AERD, causing the spectators to have an enhanced spectator experience.

In an example, a dedicated mobile app may allow spectators to place wagers on various animal event outcomes, such as the winner, podium winner, podium finishers, fastest lap, or the number of safety car period.

In another example, the engagement module 1408 may allow interaction of the target group of spectators by providing a live betting platform where spectators can use a real-time betting platform to make dynamic wagers during the animal event, adjusting their bets as the animal event unfolds.

In yet another example, the engagement module 1408 may allow interaction of the target group of spectators providing driver performance betting such in which wagers can be placed on individual driver performance, such as predicting the number of overtakes, the driver with the most laps led, or who will finish as the top-ranked driver for a particular team. In yet another example, the engagement module 1408 allows participation of the target group of spectators by using championship betting, safety car betting, driver head-to-head betting, live betting challenges, in race betting contests, and social betting pools.

In some implementations, the system 1400 may establish a two-way communication between the animal event and the spectator. The two-way communication allows the spectator to have enhanced engagement with the animal event.

In some implementations, the engagement module 1408 may enable the target group of spectators to place parimutuel wagers on the finish order. In addition, the engagement module 1408 is configured to allow the target group of spectators to use the AERD to place bets, including over and under ones, about aspects of an animal event chosen from the group consisting of the lead for the most laps, the number of laps under a caution flag, the number of caution flags, the first driver to make a pit stop, the winning animal number, whether the winning animal number is an odd or even number, and the winning animal.

In some implementations, the system 1400 may further include a data processing module (not shown in figures) configured to amalgamate and reformat the AERD into a standardized data feed that is receivable by parimutuel platforms that provide real-time odds for betting based upon the analyzed data.

In some implementations, the processor 1408b, the computer readable memory 1408c and the one or more database 1410 of the engagement module 1408 may be any of the above-mentioned processor, memory and database used for the communication subsystem 1402.

In some implementations, the system 1400 includes an allocation module configured to designate and transmit producer a portion of the wagers to the event. The allocation module splits the portion of wagers between an owner of the animal, a jockey of the animal and a trainer. In an exemplary example implementation of the techniques of the disclosure, the owner of the animal keeps 80% of the wagers and the jockey and each of the trainer received 10% of the total amount of wagers.

In some implementations, a two-way communication is established between the animal event and the spectator where the two-way communication allows the spectator to have an enhanced spectator experience during the animal event.

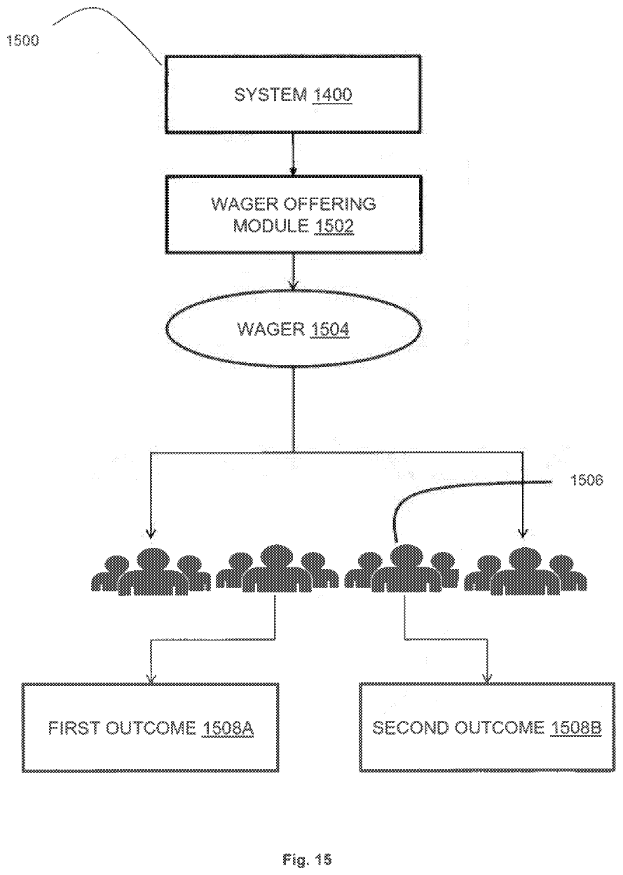

FIG. 15 is a diagrammatic representation of a wager offering module 1502 configured to offer wagers 1504 to a target group of spectators 1506 on interim outcomes between the beginning time and the completion time. In some implementations, the wager offering module 1502 may be associated with the system 1400 to enhance the experience of the target group of spectators 1506 which are engaged with the animal event.

In addition, the animal event may have “n” number of interim outcomes, where “n” is a natural number. In an exemplary example implementation of the techniques of the disclosure, the interim outcomes of the animal event may include a first outcome 1508a and a second outcome 1508b. In an example, the first outcome 1508a and the second outcome 1508b may include an animal winning a fight over the other animal during a time interval. In another example implementation of the techniques of the disclosure, the interim outcomes is chosen from the group consisting of final times and other data pertinent to animals, animal-trainers, animal-riders in a rodeo, and specific event outcomes other than final times.

FIG. 16 is a diagrammatic representation 1600 of the targeting module 1404 associated with the system 1400, in accordance with an example implementation of the techniques of the disclosure. The targeting module 1404 is configured to select a target group of spectators 1504 based on a predetermined criterion.

In accordance with an example implementation of the techniques of the disclosure, the predetermined criteria for selecting the target group of spectators 1504 may include any of a plurality of user preferences 1506a, a plurality of user demographics 1506b and a plurality of geographic locations 106c. In another example implementation of the techniques of the disclosure, the predetermined criteria for selecting the target group of spectators 1504 may include other factors influencing a user experience.

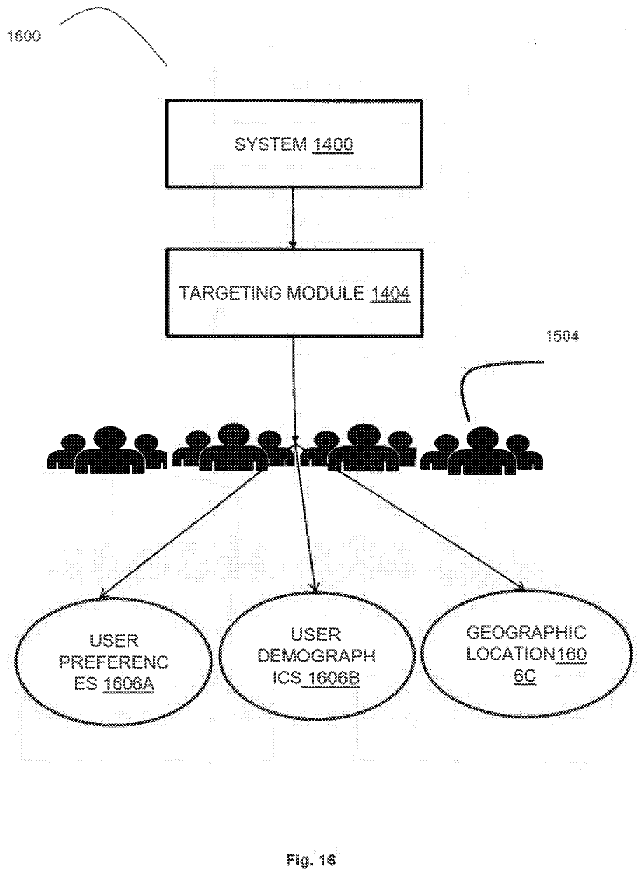

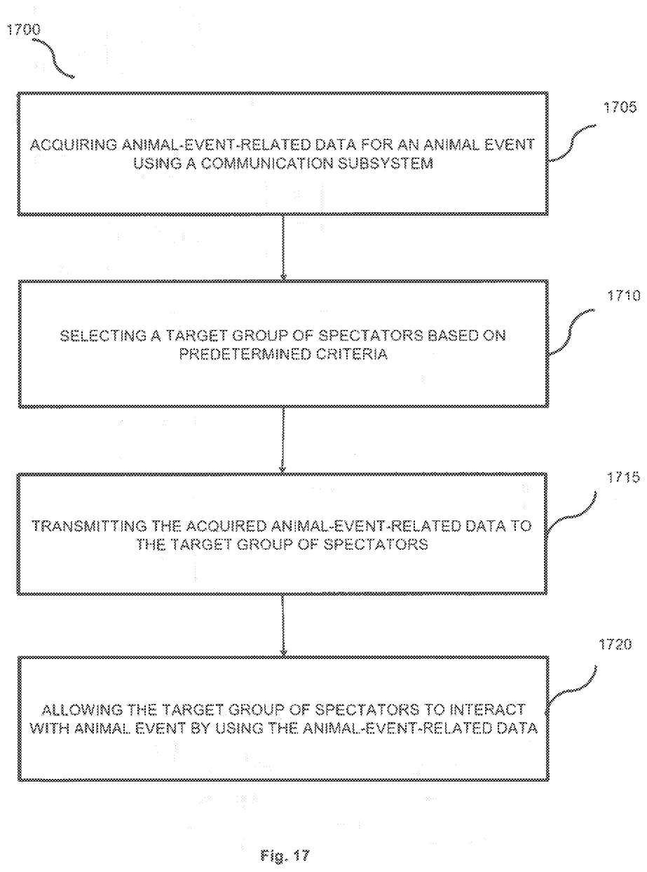

FIG. 17 is a block diagram illustrating a method 1700 for enhancing the spectator experience during an animal event, in accordance with an example implementation of the techniques of the disclosure. In some implementations, the animal event may be chosen from the group consisting of rodeos, stock shows, bullfights, and circuses. In one specific embodiment, the block diagram includes steps to illustrate the aforementioned method 1700 for enhancing the spectator experience during the animal event. Other embodiments may include other steps to illustrate similar method.

In some implementations, the method 1700 may initiate step 1705 and terminates at step 1720. At step 1705, animal-event-related data (AERD) for the animal event is acquired using a communication subsystem 1402 (References have been made to FIG. 14). In some implementations, all the AERD is amalgamated into a standardized date format to enable transmission through plural third parties involved in the animal event.

At step 1710, a target group of spectators may be selected based on predetermined criteria. In some implementations, the predetermined criteria for selecting the target group of spectators includes at least one of geographical location, user preferences, and user demographics.

At step 1715, the acquired AERD may be transmitted to the target group of spectators. At step 1720, the target group of spectators may be allowed to engage with the animal event by using the AERD to place bets about animal-event outcomes. In some implementations, the step 1720 of allowing the target group of spectators to engage with the animal event includes placing bets on various animal-event outcomes, including but not limited to final scores, player statistics, and specific game and domesticated animal events.

In some implementations, the method 1700 further includes real-time analysis of the AERD which provides updated odds for betting to the target group of spectators.

In some implementations, a computer-readable medium includes computer-executable instructions for implementing the method 1700 for enhancing spectator experience during an animal event. In an example, the computer readable medium is but not limited to a memory card which can store software and instructions, CD-ROM that can be read by a computer's optical drive, DVD, USB Flash Drive, Hard Disk Drive to store both data and execute instructions, Solid State Drive, Magnetic Tape, Cloud Storage in which files and instructions are stored like Google Drive or dropbox, network storage, remote repositories, ROM, EPROM and EEPROM.

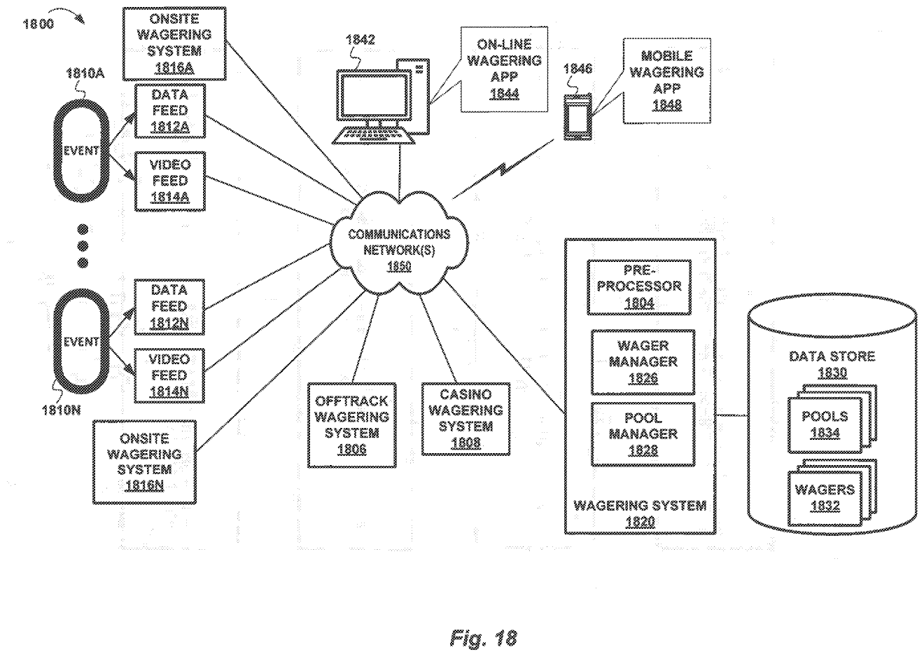

FIGS. 1-17 discussed above provide systems and methods to enhance spectators'experiences at events and for implementing pari-mutuel wagering in sports events worldwide. FIGS. 18-21 discussed below provide further techniques that may be used in addition to, or instead of, the techniques, systems, and methods described above. The techniques described below with respect to FIGS. 18-21 are directed to multi-stage events such as multi-stage motorsports events. An example of a multi-stage motorsport event is a NASCAR Cup Series event. With the exception of longer races such as the Coca Cola 600, each race in the series has three stages. Points are awarded based on finishing position of each stage. In some implementations of multi-stage racing, the race does not stop after a stage. Instead, during the period between stages, a caution period (also referred to as a yellow flag period) occurs. During this caution period, drivers slow down and maintain their position behind the car in from of them. Passing is typically not allowed during the caution period. However, a car may reduce the distance to the car in front during the caution period. This tends to make the cars grouped more closely together when the A car may make a pit stop during the caution period and can refuel, change tires, or make other adjustments. However, a car making a pit stop during the caution period loses its position and acquires a new position upon leaving the pit area. At the end of the caution period, the green flag comes out and the race resumes with the next stage.

FIG. 18 is a block diagram illustrating a system 1800 for conducting parimutuel wagering on multi-stage events. In some aspects, system 1800 wagering system 1820, data feeds 1812A-1812N, and video feeds 1814A-1814N are communicatively coupled by one or more communication networks 1850. In some aspects, the communications network(s) 1850 may include one or more networks comprising the Internet. In some aspects, the communication network(s) may include private networks.

Data feeds 1812A-1812N provide event data for a respective event 1810A-1810N to preprocessor 1804. As an example, events 1810A-1810N may be multi-stage motorsports events such as multi-stage auto racing events. In this example, a data feed corresponding to a motorsport event may include various statistics and other information regarding an event in the event data. Such statistics and information may include one or more of the start time and end time of the stage, the participants in the stage, and the results of the stage. A data feed corresponding to the event may also include supplemental data such as qualifying times of the participants, lap times, results of past races for participants or teams, performance of participants or teams against other participants or teams, scores of participants or teams of racers, and the like.

Data feeds 1812A-1812N and video feeds 1814A-1814N may be provided, for example, by sanctioning bodies associated with events 1810A-1810N. Different sanctioning bodies may provide different data elements in their respective data feeds 1812A-1812N, and the data may be in different formats. Examples of such sanctioning bodies include the North American Stock Car Racing Association (NASCAR), the Automobile Racing Club of America (ARCA), IndyCar, Fédération Internationale de l'Automobile (FIA), among others. A data feed for an event may be provided by a first entity, and the video feed for the same event may be provided by a different second entity. In some aspects, a licensed data provider may provide a data feed and/or video feed in addition to, or instead of, a sanctioning body. As an example, Al Kamel Systems of Barcelona Spain is a licensed provider of motorsports racing data.

Video feeds 1814A-1814N provide video information for a respective event 1810A-1810N to preprocessor 1804. As an example, a video feed corresponding to a multi-stage event may be video data of some or all of a stage of the event. In the example above of a motorsports event, the video data may include the entire race (e.g., the entire stage of each stage of the race) or may include portions of a race or stage (e.g., the beginning of the race or stage, the finish of the race or stage, or significant occurrences during the race or stage).

Wagering system 1820 manages wagering activities that may be associated with various types of wagering entities. Such wagering entities can include onsite wagering 1816, offtrack wagering site 1806, casino 1808, online wagering application 1844, or mobile wagering application 1848, among others. Onsite wagering 1816 includes wagering devices located at the site of an event (e.g., one of events 1810A-1810N). In some implementations, wagering system 1820 includes preprocessor 1804, wager manager 1826, and pool manager 1828.

Preprocessor 1804 receives the event data and supplemental data (if any) from data feeds 1812A-1812N and video information from video feeds 1814A-1814N. As noted above, the data provided by data feeds 1812A-1812N may include different data elements, may be in different formats, and may be differently organized from the data that can be accepted by wagering system 1820 and from one another. In some aspects, preprocessor 1804 performs data transformations to the incoming data to generate data in a format that can be accepted and correctly processed by wagering system 1820. For example, the preprocessor 1804 can transform the incoming data feeds 1812A-1812N to a standardized data format that can be accepted by a wagering system such as wagering system 1820. Such transformations may include translating or mapping values, rearranging the order of data fields, adding or deleting data fields, padding or truncating data, among others. Although shown as part of wagering system 1820, the functionality provided by preprocessor 1804 may be separate from wagering system 1820 and further may be distributed across multiple entities.

Offtrack wagering site 1806 can be a site where wagering activities can be performed that is remote from the site of the event. Special purpose devices for conducting wagering activities may be used at the offtrack wagering site 1806. Although referred to as an “offtrack” wagering site, the event need not necessarily be a track based event, but can include other multi-stage events. The offtrack wagering site 1806 can include devices for presenting information regarding racing events (e.g., multi-stage racing events) and accepting pari-mutuel wagers (also referred to as “bets”) on the racing events.

Casino 1808 can be a conventional casino that provides a variety of different wagering games and game formats. Like the offtrack wagering site 1806, the casino 1808 can include devices for presenting information regarding racing events (e.g., multi-stage racing events) and accepting pari-mutuel wagers on the racing events.

Online wagering application 1844 is an application configured for use on a computing device 1842. Computing device 1842 may be a personal computer, desktop computer, laptop computer, set-top box, Internet-of-Things (IoT) device, smart appliance, and the like. Like the devices at the offtrack wagering site 1806 and the casino 1808, the online wagering application 1844 may present information regarding racing events and accept pari-mutuel wagers on the racing events.

Mobile wagering application 1848 can be an application configured for use on a mobile device 1846. Mobile device 1846 may be a smartphone, tablet computer, navigation device, vehicle-based communication system, and the like. Like online wagering application 244, mobile wagering application 1848 can present information regarding racing events and accept pari-mutuel wagers on the racing events.

The operation of system 1800 will now be described with respect to a single event 1810A. The operation with respect to event 1810A applies as well to the other events 1810B-1810N. The events 1810A-1810N may take place at separate times from one another, or an event may take place concurrently with one or more other events. Pre-processor 1804 and wagering system 1820 may thus be processing input and providing output for multiple events.

Pre-processor 1804 may receive data from data feed 1812A via communication network 1850 prior to the beginning of the event 1812A, and may continue to receive data via data feed 1812A throughout the event 1810A. For example, prior to the beginning of a multi-stage event, pre-processor 1804 may receive data including the identities of the participants in the event (e.g., individual racers, cars, teams, etc.) that will be participating in the event. Data feed 1812A may also provide supplemental data such as qualifying times for the participants. During the multi-stage event, data feed 1812A may provide data regarding a stage of the multi-stage event. For example, the data may include an indication that the stage has started. Further, the data may include the current positions of the participants or the final position of the participants that finished the stage. Similarly, the data may include data for subsequent stages of the event, including an indication that the stage has started, current positions of participants during the stage, and/or the final positions of the participants upon completion of the stage. The data provided by data feed 1812A may also include some or all of the ERD described above.

Pre-processor 1804 receives the data from data feed 1812A, and as noted above, transforms the data into a format that can be processed by wagering system 1800. In some examples, the data from data feed 1812A may already be in a format that can be processed by wagering system 1820. In some aspects, pre-processor 1804 may pass the data through to wagering system 1820. In some other aspects, wagering system 1820 may receive the data directly from data feed 1812A, bypassing pre-processor 1804.

Wagering system 1820 receives data from data feed 1812A, either indirectly through pre-processor 1804 or directly from data feed 1812A. In some aspects, wagering system 1820 (or pre-processor 1804) may include a communication subsystem for obtaining data from the data feed 1812. As an example, the communication subsystem may be an implementation of communication subsystems 102, 502, 902, or 1402 of FIGS. 1, 5, 9, or 14, respectively.

Wagering system 1820 can provide some or all of the data (after any pre-processing if necessary) to one or more of on-line wagering application 1844, mobile wagering application 1848, onsite wagering system 1816, offtrack wagering site 1806, or casino 1808 (generically referred to as a “wager placement entity”) The wagering placement entity can display the data to a wagerer (also referred to as a “user” or “bettor”) and receive a wager type and a wager amount from the wagerer. As an example, a wager type may be “win,” “place,” or “show”. A description of various wager types that may be supported by the techniques of the disclosure is provided below.

Wagering system 1820 uses the wager types and wager amounts to determine betting odds to present to a wagerer of a wager placement entity. In some aspects, wagering system 1820 uses pari-mutuel betting techniques to determine odds and payouts. The term “pari-mutuel” is based on a French expression meaning “a wager among ourselves.” In pari-mutuel wagering, the winners share a portion of a purse that includes the amounts wagered on an event. Another portion of the purse includes a commission for the wagering system operator. In accordance with the techniques of the disclosure, another portion of the purse includes payouts to participants of the event, where the payout to a participant may be based, at least in part, on the results achieved by the participant in a stage or stages of the multi-stage event. In effect, wagered amounts of the losers are distributed among the winners, the wagering system operator, and the participants of the multi-stage event.

Wagering system 1820 can support various wager types. In some aspects, wagering system 1820 can support various combinations of one or more of the following wager types for a stage of a multi-stage event:
Win—The wagerer's selected participant finishes first of the stage.
Place—The wagerer's selected participant finishes first or second of the stage.
Show—The wagerer's selected participant finishes first, second, or third of the stage.
Exacta—The wagerer correctly selects the first and second place finishers of the stage in exact order.
Quinella—The wagerer correctly selects the first and second place finishers of the stage in any order.
Trifecta—The wagerer correctly selects the first, second, and third place finishers of the stage in exact order.
Superfecta—The wagerer correctly selects the first, second, third, and fourth place finishers of the stage in exact order.

In some implementations, the wagering system 1820 may support a wager based on the results of two or more stages of a multi-stage race. As an example, a wagerer may place a single wager on the results of each stage of a multi-stage event. For instance, a wagerer may place a wager that selects the first place finisher for each stage, or combination of stages, for the multi-stage event. As an example, a “Pick 3” option may be provided in which the wagerer wagers on the results of three stages of the multi-stage event. In some implementations, the three stages are consecutive stages of the multi-stage event. Other combinations may be offered that include fewer stages or more stages. The wager may specify the same participant as the first place finisher in each stage of the combination, or may specify different participants as the first place finisher for each stage of the combination. The wagerer may specify various combinations of stages, finishing positions, and participants when placing a wager.

In some aspects, wagering system 1820 stops accepting wagers for a stage after the stage has begun. In some aspects, wagering system 1820 stops accepting wagers for a combination of stages after the beginning of the earliest stage of the combination. In some aspects, the wagering system 1820 stops accepting wagers for every stage of the multi-stage event after the beginning of the first stage of the multi-stage event.

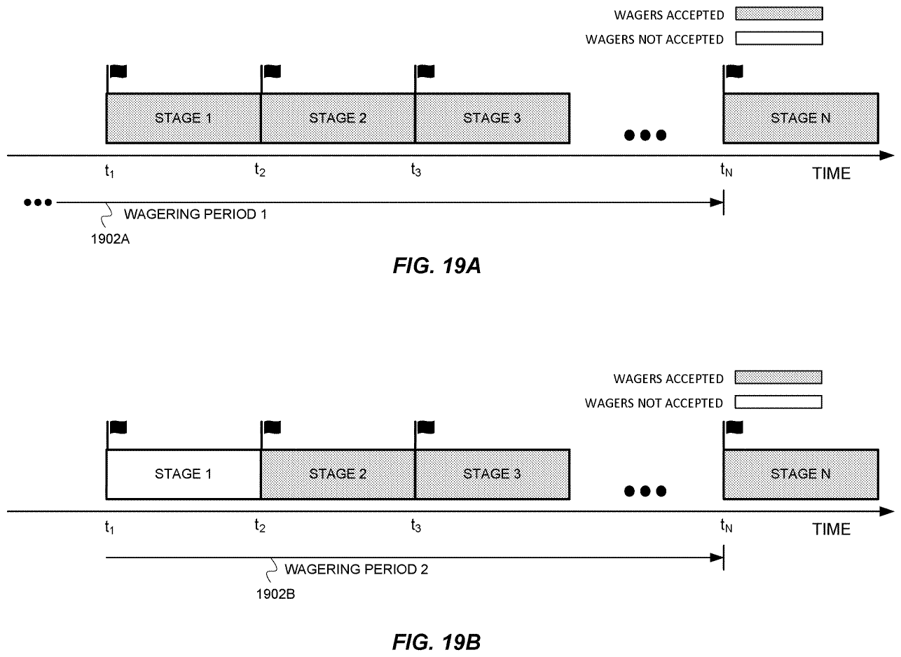

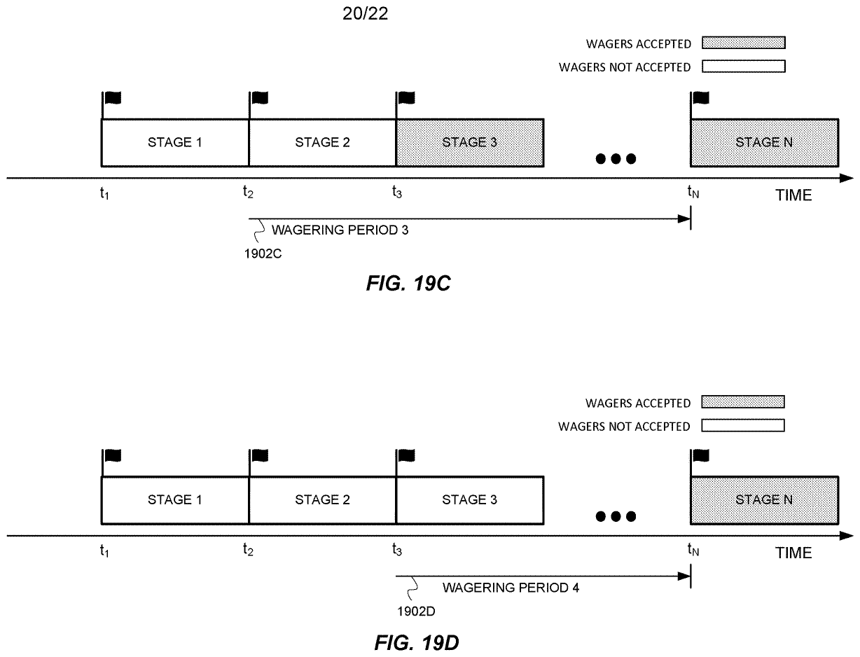

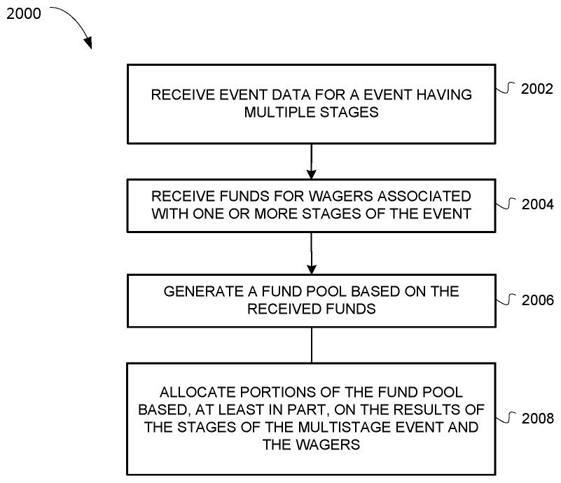

FIGS. 19A-19D illustrate wagering periods during an example multi-stage event having N stages, such as a multi-stage motorsports event. N may be a positive integer greater than 1. In some aspects, N may be three (3). In some other aspects, N may be four (4). The techniques of the disclosure are not limited to any particular value of N.

The stages 1-N of FIGS. 19A-19D are shown with the end of one stage immediately followed by the beginning of the next stage. As noted above, there may be a caution period between the end of one stage and the beginning of the next stage that is not shown in FIGS. 19A-19D. The shaded stages in FIGS. 19A-19D indicate stages for which wagers are accepted during a wagering period. Unshaded stages indicate stages for which wagers are not accepted.

FIG. 19A is a conceptual diagram illustrating an example first wagering period for a multi-stage event. In the example of FIG. 19A, a first wagering period 1902A begins prior to the start of the first stage (e.g., stage 1) of the multi-stage event at time t₁ and continues until the beginning of the final stage N at time t_{N}. During the first wagering period 1902A, a wagerer may place one or more wagers on the results of one or more of any of the stages 1-N. As noted above, the wagers may be for individual stages or they may be for combinations of two or more stages. Using the Pick 3 wagering type as an example of a combination wager, during betting period 1902A, a wagerer may place a wager of any three consecutive stages. In this case, the wagerer may specify a Pick 3 wager on the results of stages 1 to 3, 2 to 4, . . . or N-2 to N.

FIG. 19B is a conceptual diagram illustrating an example second wagering period for the multi-stage event. The example of FIG. 19B continues the example described above with respect to FIG. 19A and describes a second betting period 1902B that begins after stage 1 has begun (e.g., after time t₁) and runs until the beginning of the final stage N at time t_{N}. During the second betting period 1902B, wagering system 1820 does not accept any wagers involving the results of stage 1. Wagering system 1820 accepts wagers on the results of one or more of stages 2-N. As noted above, the wagers may be placed for the results of a single stage or for combinations of stages. Using the example of a Pick 3 wager type, during betting period 1902B, if the race is a three stage race (e.g., N=3), the Pick 3 wager type would not be available to the wagerer because wagering will only be accepted for stages 2 and 3. If the race has four or more stages (e.g., N>3), the Pick 3 type would be available with respect to stages 2 through N.

FIG. 19C is a conceptual diagram illustrating an example third wagering period for the multi-stage event. The example of FIG. 19C continues the examples described above with respect to FIGS. 19A and 19B, and describes a third betting period 1902C that begins after stage 2 has begun (e.g., after time t₂) and runs until the beginning of the final stage N at time t_{N}. During the third betting period 1902C, wagering system 1820 does not accept any wagers involving the results of stage 1 and stage 2. Wagering system 1820 accepts wagers on the results of one or more of stages 3-N. As noted above, the wagers may be placed for the results of a single stage or for combinations of stages (if there are enough stages remaining in the multi-stage event). Using the example of a Pick 3 wager type, during betting period 1902C, if the race is a three stage race (e.g., N=3), the Pick 3 wager type would not be available to the wagerer because wagering will only be accepted for stage 3. If the race has five or more stages (e.g., N>4), the Pick 3 type would be available with respect to stages 3 through N.

FIG. 19D is a conceptual diagram illustrating an example fourth wagering period for the multi-stage event. The example of FIG. 19D continues the examples described above with respect to FIGS. 19A, 19B and 19C, and describes a fourth betting period 1902D that begins after stage 3 has begun (e.g., after time t₃) and runs until the beginning of the final stage N at time t_{N}. During the fourth betting period 1902D, wagering system 1820 does not accept any wagers involving the results of stages 1, 2 and 3. Wagering system 1820 accepts wagers on the results of one or more of stages 4-N (if the event has more than three stages, e.g., N>3). As noted above, the wagers may be placed for the results of a single stage or for combinations of stages (if there are enough stages remaining in the multi-stage event).

FIGS. 19A-19D have describes implementations where wagers for a multi-stage event are accepted for any stage of the event that has not yet begun. In other implementations, wagering for every stage of the event are accepted up until the beginning of the first stage of the event.

Returning to FIG. 1, the wagering system 1820 accepts wagers for stages and combinations of stages (if supported) for those stages that have not yet begun. Wagering system 1820 can include a pool manager 1828 that maintains data in data store 1830 for the wagering activity. For example, pool manager 1820 can maintain a pool 1834 for each event 1810 that pools the wagered amount for the event. The pool may be referred to as the handle for the event. Similarly, wagering system 1820 can include a wager manager 1826 that records the wagers 1832 associated with each event. For example, wagers 1832 for an event may include the wager type, odds, and wager amount for each wager placed for a stage of an event.

Data store 1830 can be any type of data storage system, including distributed data storage systems, cloud based data storage systems, or dedicated hardware based storage systems. In some aspects, data store 1830 may be an implementation of databases 110, 510, 910, 1410 of FIGS. 1, 5, 9, and 14, respectively.

Wagering system 1820 uses the data in data store 1830 (e.g., the wagers 1832, among other data) to determine current wagering odds for the various types of wagers supported for an event. For example, wagering system 1820 can use pari-mutuel analysis techniques to generate the current wagering odds for the event based on the wagers 1832. The wagering system 1820 can transmit the current wagering odds to the various wagering placement entities that are participating in the wagering activity for use in displaying wagering information and accepting wagers.

Wagering system 1820 determines a distribution of the handle for the event (e.g., the pool of wagered funds for the event) when the results of the event are made official. In some aspects, a first portion of the handle may be allocated to the operator of the wagering game system 1820 (e.g., as a commission). A second portion of the handle may be allocated to the purse for the event that is paid out to the participants of the event. Typically, this second portion has been ten percent of the handle, but the percentage can vary. A third portion of the handle is returned to the wagerers in accordance with their corresponding wager amounts, wager types, odds, and results of the stages of the multi-stage event.

As noted above, a portion of the handle is allocated to the purse. In addition to the portion of the handle that is allocated to the purse, the purse may also include funds that are provided by the sponsors and/or entry fees. When the results of the race are determined, the purse may be distributed to the participants. For example, in some implementations, the payout of the purse for a field with more than ten participants may be as follows:
51% to the winner, (e.g., “more than half”),
20% to second,
12% to third,
8% to fourth,
5% for fifth,
Remaining 4% split equally among remaining participants.

In a field having less than ten participants, the distributions above may be changed by adding 1% additional payout to positions 1-5, thereby changing the split to 52% for first, 21% for second, 13% for third, 9% to fourth, 6% to fifth and then the balance divided equally among the remaining participants.

The distributions shown above can pay the entire field of finishers, which has an advantage over conventional systems in that it encourages participation in the sport and larger fields, which is good for the sport. The distributions shown above are for particular implementations of the techniques of the disclosure, and other implementations may use different distributions that are within the scope of the inventive subject matter. For example, in a large field, the amount shared by the participants finishing after fifth place may share in a larger percentage by reducing the percentages of one of more of first to fifth place.

In addition to receiving data via data feed 1812A, as noted above, the wagering system 1820 may receive video data from video feed 1814A associated with the event 1810A. The wagering system 1820 may provide some or all of the video data for an event to one or more of the wagering entities.

FIG. 20 is a flow chart diagram 2000 illustrating an example method for conducting parimutuel wagering on multi-stage events. The operations may be performed, for example, by wagering system 1820 of FIG. 18.

At block 2002, the wagering system receives event data for an event having multiple stages. The data may include various statistics and other information regarding the event. Such statistics and information may include one or more of the start time and end time of a stage, the participants in the stage, and the results of the stage. A data stream may also include supplemental data such as qualifying times of the participants, lap times, results of past races for participants or teams, performance of participants or teams against other participants or teams, scores of participants or teams of racers, and the like.

At block 2004, the wagering system receives wagers and funds for wagers associated with one or more stages of the multi-stage event. As noted above, the wagers may specify a wager type and a wager amount. The wagering system may record the wagers in a data store (e.g., data store 1830).

At block 2006, the wagering system generates a fund pool based on the received funds.

At block 2008, the wagering system allocates portions of the fund pool. In some aspects, the wagering system allocates at least one portion of the fund pool based, at least in part, on the results of the stages of the multi-stage event. In some aspects, the wagering system may allocate at least one portion of the fund based on the results of the stages of the multi-stage event and the wagers associated with the stages. In some aspects, the wagering system may allocate portion of the fund pool as a commission for the operator of the wagering system.

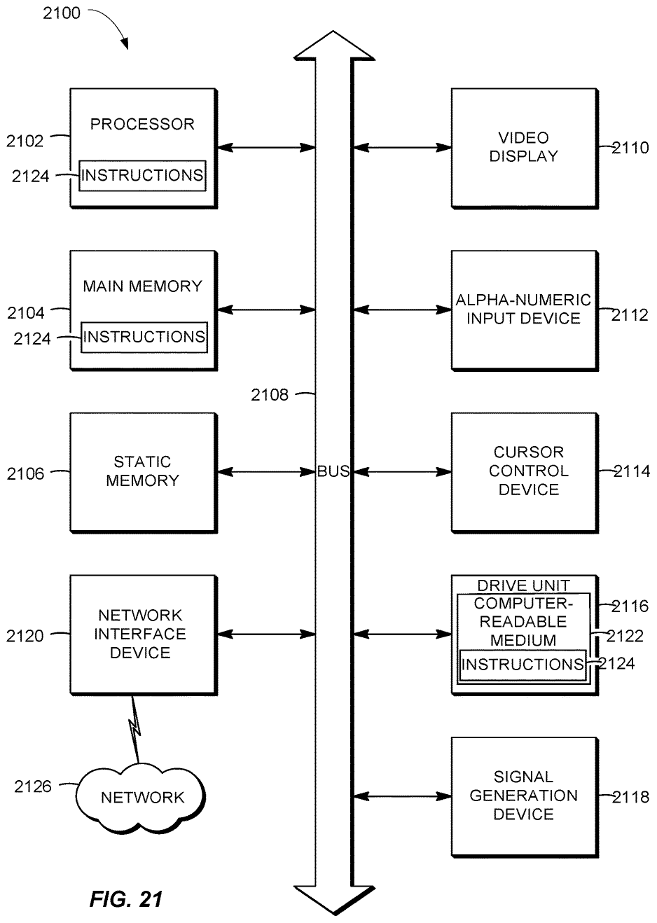

FIG. 21 is a block diagram of an example computer system upon which embodiments of the inventive subject matter can execute. The description of FIG. 21 is intended to provide a brief, general description of suitable computer hardware and a suitable computing environment in conjunction with which the invention may be implemented. In some embodiments, the inventive subject matter is described in the general context of computer-executable instructions, such as program modules, being executed by a computer. Generally, program modules include routines, programs, objects, components, data structures, etc., that perform particular tasks or implement particular data types.

As indicated above, the system as disclosed herein can be spread across many physical hosts. Therefore, many systems and sub-systems of FIG. 21 can be involved in implementing the inventive subject matter disclosed herein.

Moreover, those skilled in the art will appreciate that the invention may be practiced with other computer system configurations, including hand-held devices, multiprocessor systems, microprocessor-based or programmable consumer electronics, smart phones, network PCs, minicomputers, mainframe computers, and the like. Embodiments of the invention may also be practiced in distributed computer environments where tasks are performed by I/O remote processing devices that are linked through a communications network. In a distributed computing environment, program modules may be located in both local and remote memory storage devices.

With reference to FIG. 21, an example embodiment extends to a machine in the example form of a computer system 2100 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. Further, while only a single machine is illustrated, the term “machine” shall also be taken to include any collection of machines that individually or jointly execute a set (or multiple sets) of instructions to perform any one or more of the methodologies discussed herein.

The example computer system 2100 may include a processor 2102 (e.g., a central processing unit (CPU), a graphics processing unit (GPU) or both), a main memory 2104 and a static memory 2106, which communicate with each other via a bus 2108. The computer system 2100 may further include a video display unit 2110 (e.g., a liquid crystal display (LCD) or a cathode ray tube (CRT)). In example embodiments, the computer system 2100 also includes one or more of an alpha-numeric input device 2112 (e.g., a keyboard), a user interface (UI) navigation device or cursor control device 2114 (e.g., a mouse), a disk drive unit 2116, a signal generation device 2118 (e.g., a speaker), and a network interface device 2120.

The disk drive unit 2116 includes a machine-readable medium 2122 on which is stored one or more sets of instructions 2124 and data structures (e.g., software instructions) embodying or used by any one or more of the methodologies or functions described herein. The instructions 2124 may also reside, completely or at least partially, within the main memory 2104 or within the processor 2102 during execution thereof by the computer system 2100, the main memory 2104 and the processor 2102 also constituting machine-readable media.

While the machine-readable medium 2122 is shown in an example embodiment to be a single medium, the term “machine-readable medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable storage medium” shall accordingly be taken to include, but not be limited to, solid-state memories and optical and magnetic media that can store information in a non-transitory manner, i.e., media that is able to store information. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 2124 may further be transmitted or received over a communications network 2126 using a signal transmission medium via the network interface device 2120 and utilizing any one of a number of well-known transfer protocols (e.g., FTP, HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “machine-readable signal medium” shall be taken to include any transitory intangible medium that is capable of storing, encoding, or carrying instructions for execution by the machine, and includes digital or analog communications signals or other intangible medium to facilitate communication of such software.

The discussion of FIGS. 188-21 above has been presented in the context motorsports events having multiple stages. However, the disclosure is not limited to motorsports events. For example, the techniques of the disclosure may be readily applied to other events having multiple stages such as bicycle races (e.g., the Tour de France), multi-sport events (e.g., triathlons and the like), and other such multi-stage events.

While there has been shown, and described herein what are presently considered the preferred embodiments of the present disclosure, it will be apparent to those skilled in the art that various changes and modifications can be made therein without departing from the scope of the present disclosure as defined by the appended claims.

While certain embodiments have been described, these embodiments have been presented by way of example only and are not intended to limit the scope of the present disclosure. Indeed, the novel devices, and systems described herein may be embodied in a variety of other forms. Furthermore, various omissions, substitutions, and changes in the form of the devices, and systems described herein may be made without departing from the spirit of the present disclosure. The accompanying claims and their equivalents are intended to cover such forms or modifications as would fall within the scope and spirit of the present disclosure.

Moreover, although the techniques of the disclosure and their advantages have been described in detail, it should be understood that various changes, substitutions and alterations can be made herein without departing from the inventive subject matter as defined by the appended claims. Moreover, the scope of the present application is not intended to be limited to the particular embodiments of the machine, manufacture, composition of matter, and means, described in the specification. As one will readily appreciate from the disclosure, processes, machines, manufacture, compositions of matter, means, presently existing or later to be developed that perform substantially the same function or achieve substantially the same result as the corresponding embodiments described herein may be utilized. Accordingly, the appended claims are intended to include within their scope such processes, machines, manufacture, compositions of matter, means.

1. A method for wagering for an auction event, comprising:
providing the auction event comprising at least one offer to bidders of an item for sale and at least one unknown outcome for the at least one offer;
identifying the at least one unknown outcome to a target group prior to the start of bidding on the item for sale;
receiving funds for a plurality of wagers for the at least one unknown outcome;
generating a fund pool based on the funds received for the at least one unknown outcome;
receiving auction-related data for the item for sale, the auction-related data comprising at least one known outcome for the item for sale;
allocating portions of the fund pool based, at least in part, on the received auction-related data.

2. The method of claim 1, further comprising transmitting the auction-related data to the target group.

3. The method of claim 2, wherein the auction-related data further comprises real-time commentary.

4. The method of claim 2, wherein the auction-related data further comprises real-time bidding updates.

5. The method of claim 2, wherein the auction-related data further comprises announcements to spectators at the auction event.

6. The method of claim 1, further comprising receiving dynamic wagers for the item for sale.

7. The method of claim 1, further comprising providing real-time bid odds based on the auction-related data.

8. The method of claim 1, wherein the allocating step is based, at least in part, on the wager amount the at least one unknown outcome.

9. The method of claim 1, wherein the allocating step is based, at least in part, on the odds associated with the wager for the at least one unknown outcome.

10. The method of claim 1, wherein the allocating step is based, at least in part, on the wager type for the at least one unknown outcome.

11. The method of claim 10, wherein the wager type comprises an over/under wager based on a number set by a third party.

12. The method of claim 11, wherein the third party is the auction house promoting the auction event.

13. The method of claim 10, wherein wager type comprises predicting the exact hammer price for the auctioned item.

14. The method of claim 10, wherein the wager type comprises predicting the hammer price for the auctioned item within a specific percentage range.

15. The method of claim 14, wherein the wager type comprises predicting the hammer price within five percent.

16. The method of claim 14, wherein the wager type comprises predicting the hammer price within ten percent.

17. The method of claim 10, wherein the wager type comprises predicting a total final hammer price for a specified combination of items being auctioned,

18. The method of claim 17, wherein the wager type comprises predicting the total combined hammer price within a specific percentage range.

19. The method of claim 17, wherein the wager type comprises predicting the total combined hammer price within five percent.

20. The method of claim 17, wherein the wager type comprises predicting the total combined hammer price within ten percent.

21. The method of claim 1, wherein the allocating step comprises allocating a first portion of the fund pool to one or more persons that placed a wager for the item for sale.

22. The method of claim 1, wherein the allocating step comprises allocating a second portion of the fund pool to an operator of a wagering service.

23. The method of claim 1, wherein the allocating step comprises allocating a third portion of the fund pool to a jurisdictional regulatory gaming agency.

24. The method of claim 1, wherein the allocating step comprises allocating a fourth portion of the fund pool to the auction house promoting the auction event.
